(19) United States
(12) Patent Application Publication
(10) Pub. No.: US 2005/0172843 A1
(43) Pub. Date: Aug. 11, 2005

(54) Stack of lithographic printing plate precursors

(75) Inventor: Norio Aoshima, Shizuoka (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/047,737

(22) Filed: Feb. 2, 2005

(30) Foreign Application Priority Data
Feb. 6, 2004 (JP) P. 2004-030710

(51) Int. Cl. B41N 1/00; B65D 85/62

(52) U.S. Cl. 101/453; 206/455

(57) ABSTRACT

A stack of lithographic printing plate precursors, which comprises: at least one lithographic printing plate precursor comprising: an aluminum support having a roughened surface; and an image recording layer comprising (A) an infrared absorber, (B) a polymerization initiator and (C) a polymerizable compound, wherein the image recording layer is capable of being removed with at least one of a printing ink and a fountain solution; and an interleaving sheet interposed between a first one and a second one of said at least one lithographic printing plate precursor, wherein said at least one lithographic printing plate precursor has a dynamic friction coefficient between an outermost surface of said at least one lithographic printing plate precursor and the interleaving sheet of 0.25 to 0.70.

### BACKGROUND OF THE INVENTION

1. Field of the Invention

The present invention relates to a stack of lithographic printing plate precursors. More specifically, the present invention relates to a stack comprising a lithographic printing plate precursor capable of image recording on the basis of digital signals such as computer data and capable of on-press development, and an interleaving sheet.

2. Description of the Related Art

A lithographic printing plate generally comprises a lipophilic image area that receives ink and a hydrophilic non-image area that receives a fountain solution in printing. Lithographic printing is a printing method of making difference in ink-adhering property on the surface of a lithographic printing plate with the lipophilic image area of the lithographic printing plate as the ink-receptive area and the hydrophilic non-image area as the fountain solution-receptive area (ink-repellent area) by making use of the natures of water and oily ink of repelling to each other, adhering ink only on the image area, and transferring the ink to the material to be printed, e.g., paper.

For manufacturing this lithographic printing plate, a lithographic printing plate precursor (a PS plate) comprising a hydrophilic support having provided thereon a lipophilic photosensitive resin layer (an image-recording layer) has so far been widely used. The lithographic printing plate is generally obtained by a plate-making method of performing exposure of a lithographic printing plate precursor through an original image of a lith film and the like, and then, for leaving the image-recording layer of the image area, dissolving and removing the image-recording layer of the non-image area with an alkaline developer or an organic solvent, to whereby bare a hydrophilic support surface.

In a related-art plate-making process of a lithographic printing plate precursor, a process of dissolving and removing a non-image area with a developer and the like corresponding to the image-recording layer after exposure is necessary, but the exclusion or simplification of such an additional wet process is one of the objects in the industry. Since the disposal of waste solutions discharged with wet processes is a particularly great interest in the industry at large in recent years from the consideration of the global environment, the solution of the above problem is increasingly desired.

For a non-processing (non-development) type plate making process that does not necessitate a wet process, a lithographic printing plate precursor having an image-recording layer whose affinity with a fountain solution or ink changes on the surface by exposure and capable of printing without being accompanied by the removal of an image-recording layer is proposed.

As a simple plate-making method, a method that is called on-press development is proposed, which is a method of using an image-recording layer capable of removing a non-image area of a lithographic printing plate precursor in an ordinary printing process, and removing a non-image area after exposure on a printing press to whereby obtain a lithographic printing plate.

As the specific examples of on-press development, e.g., a method of using a lithographic printing plate precursor having an image-recording layer soluble or dispersible in, e.g., a fountain solution, or an emulsified product of an ink solvent or a fountain solution and ink, a method of mechanically removing an image-recording layer by the contact with the rollers and the blanket of a press, and a method of mechanically removing an image-recording layer by the contact with the rollers and the blanket after weakening the cohesive strength of an image-recording layer or the adhesive strength of an image-recording layer and a support by the permeation of a fountain solution and an ink solvent are exemplified.

In the present invention, unless otherwise indicated, “development process” means a process of removing an unexposed area with infrared laser beams of a lithographic printing plate precursor by being brought into contact with a liquid (generally an alkaline developer) to thereby bare the hydrophilic support surface with an apparatus other than a printing press (generally an automatic processor), and “on-press development” means a method and a process of removing an unexposed area with infrared laser beams of a lithographic printing plate precursor by being brought into contact with a liquid (generally printing ink and/or a fountain solution) to whereby bare the hydrophilic support surface with a printing press.

However, when a related-art image-recording layer of an image-recording system utilizing ultraviolet rays and visible rays is used, it is necessary to take methods requiring much labor, such that the exposed lithographic printing plate precursor must be stored under a completely light-shielding condition or a constant temperature condition until it is mounted on a printing press, since the image-recording layer is not fixed after exposure.

On the other hand, in recent years, digitized techniques of electronically processing, accumulating and outputting image data using a computer have prevailed, and various image output systems corresponding to these digitized techniques have been put to practical use. Under such circumstances, a computer-to-plate technique of directly making a printing plate is attracting public attention, which technique comprises scanning exposing a lithographic printing plate precursor with high convergent radiant rays such as laser beams carrying digitized image data without using a lith film. With such a tendency, it is an important technical subject to obtain a lithographic printing plate precursor well adapted to such a technique.

Accordingly, in recent years, the simplification of plate-making operation, and the realization of dry system and non-processing system have been further strongly required from both aspects of the above-described global environmental protection and the adaptation for digitization.

Since high output lasers such as semiconductor lasers and YAG lasers radiating infrared rays of the wavelength of from 760 to 1,200 nm are inexpensively available nowadays, methods of using these high output lasers as the image recording means are now promising as the manufacturing method of a lithographic printing plate by scanning exposure that is easy to be included in digitized techniques.

In related-art plate-making methods, a photosensitive lithographic printing plate precursor is imagewise exposed by low to middle intensity of illumination, and image recording is performed by the imagrwise changes of physical properties in the image-recording layer by photochemical reaction. While in the above method of using high output lasers, an exposure area is irradiated with a great quantity of light energy in an extremely short period of time, the light energy is efficiently converted to heat energy, the heat energy is used to cause heat changes such as chemical changes, phase changes and morphological changes in the image-recording layer, and these changes are utilized in image-recording. Accordingly, image data are inputted by light energy, e.g., laser beams, but image recording is performed in the state including the reaction by heat energy in addition to light energy. A recording system making use of heat generation by such high power density exposure is generally called heat mode recording, and converting light energy to heat energy is called light/heat conversion.

Great advantages of the plate-making method using heat mode recording are that image-recording layers are photo-insensitive to the lights of ordinary levels of illuminance such as room illumination, and that the fixation of images recorded by high illuminance exposure is not necessary. That is, lithographic printing plate precursors for use in heat mode recording are free of sensitization by room illumination before exposure and the fixation of images is not essential after exposure. Accordingly, a printing system that an image is not influenced even if exposed to room light after exposure becomes possible by using, e.g., an image-recording layer which is solubilized or insolubilized by exposure with high output laser beams and performing a plate-making process with the imagewise exposed image-recording layer by on-press development. Therefore, it is expected that a lithographic printing plate precursor preferably used for on-press development will be possible to be obtained if heat mode recording is used.

As one example, a lithographic printing plate precursor comprising a hydrophilic support having provided thereon an image-forming layer containing hydrophobic thermoplastic polymer particles dispersed in a hydrophilic binder agent is disclosed in Japanese Patent No. 2938397. Japanese Patent No. 2938397 discloses that it is possible to perform on-press development with a fountain solution and/or ink by subjecting the lithographic printing plate precursor to exposure with infrared laser beams to coalesce the hydrophobic thermoplastic polymer particles by heat to thereby form an image, and then mounting the lithographic printing plate precursor on the cylinder of a printing press.

However, it was found that a method of forming an image by coalescence of fine particles by mere heat fusion as above certainly shows a good on-press developing property, but image-recording layer strength is weak and press life is insufficient.

Further, lithographic printing plate precursors containing microcapsules containing a polymerizable compound on a hydrophilic support are disclosed in JP-A-2001-277740 and JP-A-2001-277742.

Further, a lithographic printing plate precursor comprising a support having provided thereon a photosensitive layer containing an infrared absorber, a radical polymerization initiator and a polymerizable compound is disclosed in JP-A-2002-287334.

These document disclose that press life can be improved by heightening the density of chemical bonding of an image area by polymerization reaction as compared with an image area formed by the heat fusion of polymer fine particles.

### SUMMARY OF THE INVENTION

In general, when a plurality of lithographic printing plate precursors are carried, a means of forming a stack by interlaminating interleaving sheets having a function of protecting coating layers such as an image-recording layer and a protective layer from mechanical impact between lithographic printing plate precursors is used. However, in the on-press development type lithographic printing plate precursor utilizing the above polymerization reaction, the image-recording layer contains a great amount of low molecular weight components, so that the image-recording layer strength before exposure is low, and scratch resistance in carriage and exposure is insufficient. For example, when the stack comprising lithographic printing plate precursors and interleaving sheets are carried or the stack is set in an exposure unit having an autoloader and the interleaving sheets are peeled off, the friction between the outermost surface of the coating layer and the interleaving sheet sometimes triggers off a scratch on the outermost surface. When a scratch occurs, undesired hardening reaction is caused from that place in the non-image area, which in some case results in scratch-like print soiling, or generation of a scratch-like blank area on an image due to insufficient hardening reaction in the image area.

That is, an object of the present invention is to provide a stack of lithographic printing plate precursors improved in a scratch resisting property at the time of carriage and exposure and capable of image recording by infrared lasers and on-press development.

The present inventors found that all the scratches of a stack of lithographic printing plate precursors which are generated during storage and carriage, or caused due to the autoloader of an exposure unit, and a blank area and soiling ascribable to scratches can be prevented when the dynamic friction coefficient of an interleaving sheet and the outermost surface of a lithographic printing plate precursor is in a specific range, thus the present invention has been achieved.

That is, the present invention is as follows.

(1) A stack of lithographic printing plate precursors, which comprises:
at least one lithographic printing plate precursor comprising: an aluminum support having a roughened surface; and an image recording layer comprising (A) an infrared absorber, (B) a polymerization initiator and (C) a polymerizable compound, wherein the image recording layer is capable of being removed with at least one of a printing ink and a fountain solution; and
an interleaving sheet interposed between a first one and a second one of said at least one lithographic printing plate precursor,
wherein said at least one lithographic printing plate precursor has a dynamic friction coefficient between an outermost surface of said at least one lithographic printing plate precursor and the interleaving sheet of 0.25 to 0.70.

(2) The stack of lithographic printing plate precursors as described in (1) above,
wherein an interleaving sheet is interposed between each of a first one and each of a second one of said at least one lithographic printing plate precursor.

(3) The stack of lithographic printing plate precursors as described in (1) or (2) above, which further comprises an interleaving sheet as a top of the stack of lithographic printing plate precursors.

(4) The stack of lithographic printing plate precursors as described in any of (1) to (3) above,
wherein the outermost surface is a surface to be exposed when the interleaving sheet is removed.

(5) The stack of lithographic printing plate precursors as described in (4) above,
wherein the outermost surface is an outermost surface of the image recording layer.

(6) The stack of lithographic printing plate precursors as described in (4) above,
wherein said at least one lithographic printing plate precursor further comprises at least one layer on the image recording layer,
wherein the outermost surface is an outermost surface of one of said at least one layer that is an opposite side of the aluminum support.

(7) The stack of lithographic printing plate precursors as described in any of (1) to (6) above, further comprising a protecting board.
(8) The stack of lithographic printing plate precursors as described in any of (1) to (7) above,
wherein the image recording layer further comprises microcapsules encapsulating at least one of (A) an infrared absorber, (B) a polymerization initiator and (C) a polymerizable compound.

(9) The stack of lithographic printing plate precursors as described in any of (1) to (8) above,
wherein the image recording layer further comprises (D) inorganic particles.

(10) A packaged stack comprising:
a stack of lithographic printing plate precursors as described in any of (1) to (9) above; and
a package.

(11) The packaged stack as described in (10) above,
wherein the package is a wrapper.

### BRIEF DESCRIPTION OF THE DRAWINGS

FIG. 1 is a drawing showing one embodiment of a package structure of a stack of lithographic printing plate precursors of the invention; and

FIG. 2 is a drawing showing one embodiment of a package structure of a stack of lithographic printing plate precursors of the invention.

### DETAILED DESCRIPTION OF THE INVENTION

The stack of lithographic printing plate precursors according to the present invention is a stack formed by interlaminating and integrating a lithographic printing plate precursor comprising a surface roughening treated aluminum support having provided thereon an image recording layer containing (A) an infrared absorber, (B) a polymerization initiator, and (C) a polymerizable compound, capable of being removed with printing ink and/or a fountain solution, and an interleaving sheet by turns, wherein the dynamic friction coefficient between the outermost surface of the lithographic printing plate precursor and the interleaving sheet is from 0.25 to 0.70.

The outermost surface of the lithographic printing plate precursor here means the outermost surface of the image recording layer side of the lithographic printing plate precursor. That is, where there is no further coating layer on the image-recording layer, the outermost surface means the image recording layer surface, and where there is further a coating layer such as a protective layer, it means the surface of that coating layer.

The stack is described in detail below.

Interleaving Sheet:

As the interleaving sheets for use in the present invention, it is preferred to select low cost stock materials for suppressing the material costs, for example, paper using 100 weight % of wood pulp, paper using the mixture of wood pulp and synthetic pulp, and paper obtained by providing a low density or high density polyethylene layer on the surfaces of these papers can be used. In particular, papers not using synthetic pulp and a polyethylene layer are low in material costs, so that interleaving sheets can be manufactured at low costs. Specifically, an interleaving sheet preferably used in the invention is paper made by using a stuff obtained by beating bleached kraft pulp and being diluted to concentration of 4 weight %, adding a size agent in 0.1 weight % of the weight of the base paper and 0.2 weight % of a strengthening agent, and further adding aluminum sulfate in an amount to reach pH of 5.0, and having a basis weight (according to the measuring method prescribed in JIS P 8124) of from 9 to 60 g/m², preferably from 35 to 50 g/m², a thickness (according to the measuring method prescribed in JIS P 8118) of from 42 to 80 μm, preferably from 45 to 65 μm, and more preferably from 45 to 55 μm. As chemical requisites of a preferred interleaving sheet are that, after finely cutting 20 g of a sample, putting the cut sample in 100 g of pure water, and sealing and heating at 110° C. for 10 minutes, NH₃ gas is not detected with NH₃ gas detecting method by Kitagawa gas detector tube system (for 20 ppm), and, further, white turbidity is not observed by the detecting method of observing the presence of white turbidity of chloride by putting 3 ml of the interleaving sheet sample in 6 ml of distilled water, and dripping two drops of a 1 weight % silver nitrate solution. Further, preferred requisites as interleaving sheets as to mechanical and strength characteristics are summarized in the following Table 1 together with the above packing degree and chemical requisites, however, interleaving sheets are not limited thereto.

For example, neutral papers using combination of a calcium carbonate filler and alkyl ketene dimer series size agents can be used as interleaving sheets in place of using the aluminum sulfate filler and corresponding rosin series size agents.

TABLE 1

| | | | | Measuring |
|---|---|---|---|---|
| | Item | Unit | Value | Method |
| 1 | Weight | g/m² | 29-60 | JIS P 8124 |
| 2 | Thickness | mm | 42-80 | JIS P 8118 |
| 3 | Thickness difference | mm | 8 or less | Note 1 |
| 4 | Moisture content | % | 4.0-6.0 | JIS P 8127 |
| 5 | Tensile strength | kN | 1.31 or more | JIS P 8113 |
| | (machine direction) | | | |
| 6 | Tensile strength | kN | 0.65 or more | JIS P 8113 |
| | (transverse direction) | | | |
| 7 | Tearing strength | mN | 147 or more | JIS P 8116 |
| | (machine direction) | | | |
| 8 | Tearing strength | mN | 196 or more | JIS P 8116 |
| | (transverse direction) | | | |
| 9 | Degree of shrinkage (factor) | % | 0.7 or less | Note 2 |
| 10 | Air permeability | sec. | 8 or more | JIS P 8117 |
| 11 | Smoothness (front surface) | sec. | 50 or more | JIS P 8119 |
| 12 | Smoothness (back surface) | sec. | 5 or more | JIS P 8119 |
| 13 | Extract pH | — | 5.3 ± 0.5 | JIS P 8133 |
| 14 | Specific volume resistance | U · cm | 1.0 × 10¹⁰ or | Note 3 |
| | | | more | |
| 15 | Specific surface resistance | U | 1.0 × 10⁹ or | Note 4 |
| | | | more | |
| 16 | Static friction coefficient | — | 0.35 or more | Note 5 |
| 17 | NH₃ gas | — | Must not be | Note 6 |
| | | | detected. | |
| 18 | Chloride | — | Must not be | Note 7 |
| | | | white turbid. | |

Measuring conditions: Items other than those individually specified were measured at 20 ± 2° C. and 65 ± 2% RH.

Notes in the column of measuring method in Table 1 are as follows.
Note 1: The difference between the maximum value and the minimum value of the thickness of one sheet of interleaving sheets measured at arbitrary position according to JIS P 8118.
Note 2: Taking the dimension of the interleaving sheet dried at 110° C. for 1 hour as dimension (A), and the dimension allowed to stand at 20° C. 65% RH for 3 hours thereafter as dimension (B), degree of shrinkage (factor) shown by “Degree of shrinkage (factor)=(B·A)/A×100”.
Note 3: After cutting the interleaving sheet in a size of 150 mm×150 mm and being allowed to stand at 20° C. 65% RH for 3 hours or more, volume resistance value (Rv) is measured under the same environment with a high sensitivity vibrating reed universal electrometer (MMAI·17 and P-601) (manufactured by Kawaguchi Electric Works Co., Ltd.). The specific volume resistance value (ρv) is obtained from the product of the volume resistance value (Rv) and the electrode area of the measuring apparatus (19.62 cm²) divided by the thickness of interleaving sheet (t), i.e., ρv=19.62/t×Rv.
Note 4: After cutting the interleaving sheet in a size of 150 mm×150 mm and being allowed to stand at 20° C. 65% RH for 3 hours or more, surface resistance value is measured under the same environment with a high sensitivity vibrating reed universal electrometer (MMAII·17 and P·601) (manufactured by Kawaguchi Electric Works Co., Ltd.). The specific surface resistance value (ρs) is obtained from the product of the surface resistance value (Rs) and the coefficient computed from the electrode area of the measuring apparatus (18.7), i.e., ρs=18.7×Rs.
Note 5: The static friction coefficient with the image forming surface of the lithographic printing plate.
Note 6: The value obtained by finely cutting 20 g of the sample, putting the cut sample in 100 g of pure water, sealing and heating at 110° C. for 10 minutes, and then measuring with Kitagawa gas detector tube system (for 20 ppm).
Note 7: 3 ml of the interleaving sheet sample is put in 6 ml of distilled water, two drops of a 1 weight % silver nitrate solution are dripped thereto, and the presence of white turbidity is visually judged.

Of the above specification of interleaving sheet, preferred specification is that the basis weight is from 30 to 60 g/m², the smoothness measured according to the measuring method of Beck's smoothness prescribed in JIS 8119 is from 10 to 100 sec., the moisture content measured according to the measuring method of moisture content prescribed in JIS 8127 is from 4 to 8 weight %, and the density is from 0.7 to 0.9 g/cm³. Dynamic friction coefficient of interleaving sheet with the outermost surface of lithographic printing plate precursor:

In the present invention, the advantageous dynamic friction coefficient of an interleaving sheet with the outermost surface of a lithographic printing plate precursor which can reduce physical defects such as blank area and the troubles in the operation of an autoloader, etc., is the range of from 0.25 to 0.7, more preferably from 0.30 to 0.65. When the dynamic friction coefficient exceeds the upper limit of this specific range, scratches are liable to occur, while when it is lower than the lower limit, the handling aptitude deteriorates, carriage as one body of interleaving sheets with lithographic printing plate precursors and the removal of interleaving sheets after that do not go smoothly, and scratches are not reduced. The operating property lowers when the outermost surface of a lithographic printing plate precursor on an interleaving sheet is too slippery, so that the dynamic friction coefficient is more preferably 0.33 or more, for easy removal of interleaving sheets, the dynamic friction coefficient is preferably 0.68 or less, and more preferably from 0.35 to 0.65 from the points of easiness of plate setting before exposure, prevention of scratches in taking out the plate by arms, and avoidance of the influence of the air of fan.

The dynamic friction coefficient can be brought into the above range by means of either a lithographic printing plate precursor or an interleaving sheet, or both of them. Further, it can be achieved by surface-lubricating treatment and adjustment of the compositions of a lithographic printing plate precursor and/or the interleaving sheet. That is, the dynamic friction coefficient can be easily controlled by the use of nonionic and ampholytic surfactants or fluorine-containing copolymers and other sliding agents for an image-recording layer, and in some cases, by the selection of the kind and the adjustment of the amount of rosins and size agents such as alkyl ketene dimers added to an interleaving sheet. The frictional characteristics of an interleaving sheet can also be controlled by immersion in the aqueous solution of surfactants or the solution of a sliding agent typified by glyceride of stearic acid. The frictional characteristics can also be controlled by the control of the surface roughness of an interleaving sheet. Accordingly, it can be controlled by the adjustment of the temperature and application conditions in calendering treatment in paper making process.

The dynamic friction coefficient of an interleaving sheet with the outermost surface of a lithographic printing plate precursor can be measured by well known arbitrary methods, but the method prescribed in JIS P 8147 is preferred for the reason that the measurement can be performed easily and with practically sufficient accuracy. The measurement is done on the outermost surface of a lithographic printing plate precursor and the surface of an interleaving sheet practically in contact with the outermost surface.

Stack:

The lithographic printing plate precursor in the invention forms a stack by interlamination with an interleaving sheet as described above by turns. Furthermore, the stack is shipped, transported and stored in the form of a package.

Protecting boards and wrappers may be used or may not be used in a package structure of lithographic printing plate precursors for making the package form of a stack, and the package forms also include a skid type package of packaging the stack of lithographic printing plate precursors placed on skids, and a paper pallet type package of packaging the stack placed on paper pallet, in addition to ordinarily used corrugated cardboard boxes.

The specific examples of the package structure of the lithographic printing plate precursors is described below with reference to the accompanying Figures.

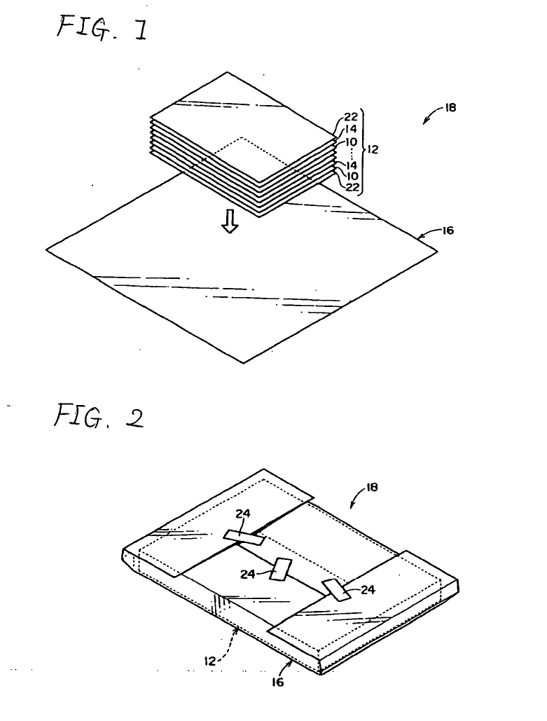

As shown in FIG. 1, package structure of lithographic printing plate precursors 18 comprises stack of lithographic printing plate precursors 12 (stack) formed by interlaminating interleaving sheet 14 and lithographic printing plate precursor 10 by turns and arranging protecting boards 22 on the top and bottom of the interlamination (the requisites of the protecting board are the same as those of the interleaving sheet described above). An interleaving sheet is interposed between each of a first one and each of a second one of lithographic printing plate precursors, in other words, each of a first one and each of a second one of lithographic printing plate precursors are only separated by an interleaving sheet. Stack 12 is packaged with wrapper 16 of a different example of the interleaving sheet.

The number of lithographic printing plate precursor 10 constituting one stack 12 is not particularly restricted, but the number is, for example, preferably from 10 to 100 plates from the viewpoint of the efficiency of transportation and storage, and easiness of mounting stack 12 on an automatic plate-making machine. When stack 12 is constituted of 10 to 100 plates of lithographic printing plate precursors 10, it is preferred to fasten lithographic printing plate precursors 10 and protecting boards 22 with a fastening means such as an adhesive tape so that they do not skid from each other. Stack 12 may be composed of several thousands plates of lithographic printing plate precursors 10. In the stack 12, protecting board 22 may be interlaminated every 20 to 100 plates of lithographic printing plate precursors 10, or protecting board 22 may be arranged only in the top and bottom of the stack 12.

In any form of stack 12, protecting board 22 may be omitted.

Stack 12 thus constituted is packaged with wrapper 16, and the folds of wrapper 16 are fastened with adhesive tape 24 as shown in FIG. 2 so that wrapper 16 is not unfolded inadvertently or slips off, whereby package structure of lithographic printing plate precursors 18 is constituted. By such packaging, lithographic printing plate precursors 10 is securely shielded from light and moisture by wrapper 16.

Package structure of lithographic printing plate precursors 18 may be encased in an outer packaging box and outer packaged or loaded on a pallet as required.

Lithographic Printing Plate Precursor:

The lithographic printing plate precursor in the present invention comprises a surface roughening treated aluminum support having provided thereon an image recording layer comprising (A) an infrared absorber, (B) a polymerization initiator, and (C) a polymerizable compound, and capable of being removed with printing ink and/or a fountain solution. Each constitutional element of the lithographic printing plate precursor is described below.

(A) Infrared Absorber:

Infrared absorbers are used in the image-recording layer in the invention for increasing sensitivity to infrared lasers. Infrared absorbers have a function to convert absorbed infrared rays to heat. Infrared absorbers fore use in the invention are dyes or pigments having an absorption maximum in the wavelength of from 760 to 1,200 nm.

As dyes for this purpose, commercially available dyes and well known dyes described in literatures, e.g., Senryo Binran (Dye Handbook), compiled by Yuki Gosei Kagaku Kyokai (1970) can be used. Specifically, azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium salts and metal thiolate complexes are exemplified.

As preferred dyes, e.g., the cyanine dyes disclosed in JP-A-58-125246, JP-A-59-84356 and JP-A-60-78787, the methine dyes disclosed in JP-A-58-173696, JP-A-58-181690 and JP-A-58-194595, the naphthoquinone dyes disclosed in JP-A-58-112793, JP-A-58-224793, JP-A-59-48187, JP-A-59-73996, JP-A-60-52940 and JP-A-60-63744, the squarylium dyes disclosed in JP-A-58-112792, and the cyanine dyes disclosed in British Patent 434,875 are exemplified.

Further, the near infrared-absorbing sensitizers disclosed in U.S. Pat. No. 5,156,938 are also preferably used, in addition, the substituted arylbenzo(thio)pyrylium salts disclosed in U.S. Pat. No. 3,881,924, the trimethine thiapyrylium salts disclosed in JP-A-57-142645 (corresponding to U.S. Pat. No. 4,327,169), the pyrylium-based compounds disclosed in JP-A-58-181051, JP-A-58-220143, JP-A-59-41363, JP-A-59-84248, JP-A-59-84249, JP-A-59-146063 and JP-A-59-146061, the cyanine dyes disclosed in JP-A-59-216146, the pentamethine thiopyrylium salts disclosed in U.S. Pat. No. 4,283,475, and the pyrylium compounds disclosed in JP-B-5-13514 (the term “JP-B” as used herein refers to an “examined Japanese patent publication”) and JP-B-5-19702 are also preferably used in the present invention. As other examples of preferred dyes, the near infrared ray-absorbing dyes disclosed in U.S. Pat. No. 4,756,993 as the compounds represented by formulae (I) and (II) can be exemplified.

As other preferred examples of infrared absorbing dyes in the invention, the indolenine cyanine dyes disclosed in JP-A-2002-278057 as shown below are exemplified.

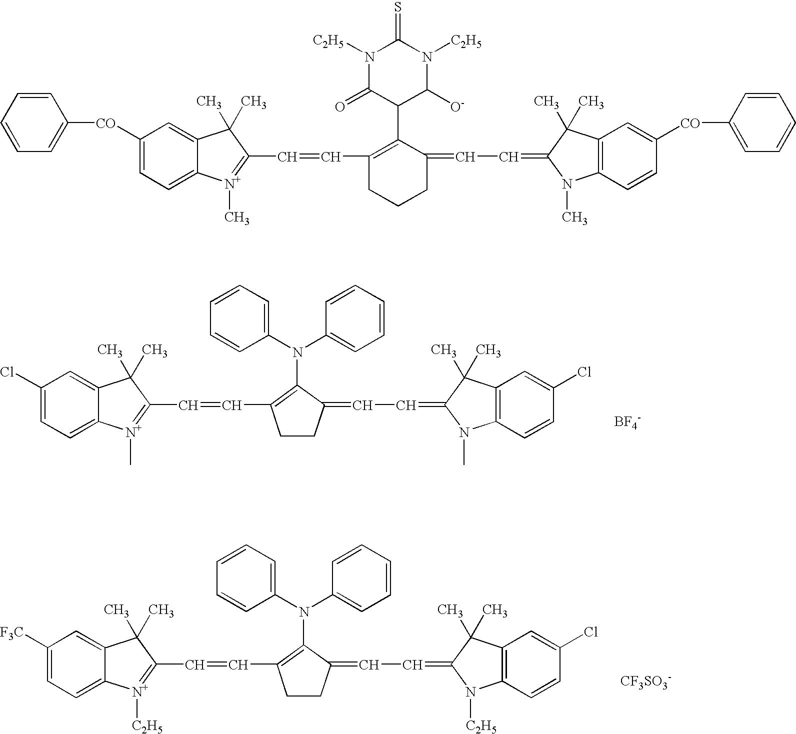

Of these dyes, cyanine dyes, squarylium dyes, pyrylium salts, nickel thiolate complexes and indolenine cyanine dyes are exemplified as particularly preferred dyes. Cyanine dyes and indolenine cyanine dyes are more preferred, and as the particularly preferred example, a cyanine dye represented by the following formula (I) is exemplified. 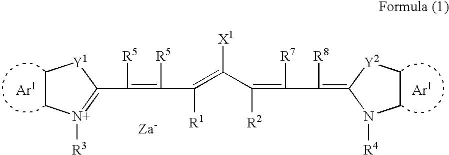
wherein X¹ represents a hydrogen atom, a halogen atom, —NPh₂, X²-L¹, or a group shown below; X² represents an oxygen atom, a nitrogen atom or a sulfur atom; L¹ represents a hydrocarbon group having from 1 to 12 carbon atoms, an aromatic ring having a hetero atom, or a hydrocarbon group comprising a hetero atom having from 1 to 12 carbon atoms. The hetero atoms used are N, S, O, a halogen atom and Se. Xₐ⁻ is defined as the same with the later-described Zₐ⁻, and R^{a} represents a substituent selected from a hydrogen atom, an alkyl group, an aryl group, a substituted or unsubstituted amino group and a halogen atom.

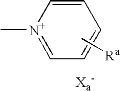

In formula (I), R¹ and R² each independently represents a hydrocarbon group having from 1 to 12 carbon atoms. In view of the storage stability of a recording layer coating solution, R¹ and R² each preferably represents a hydrocarbon group having 2 or more carbon atoms, and particularly preferably R¹ and R² are bonded to each other to form a 5- or 6-membered ring.

Ar¹ and Ar², which may be the same or different, each independently represents an aromatic hydrocarbon group which may have a substituent. The examples of preferred aromatic hydrocarbon groups include a benzene ring and a naphthalene ring. The preferred examples of the substituents include a hydrocarbon group having 12 or less carbon atoms, a halogen atom, and an alkoxyl group having 12 or less carbon atoms. Y¹ and Y², which may be the same or different, each independently represents a sulfur atom or a dialkylmethylene group having 12 or less carbon atoms. R³ and R⁴, which may be the same or different, each independently represents a hydrocarbon group having 20 or less carbon atoms which may have a substituent. The preferred examples of the substituents include an alkoxyl group having 12 or less carbon atoms, a carboxyl group and a sulfo group. R⁵, R⁶, R⁷ and R⁸, which may be the same or different, each independently represents a hydrogen atom or a hydrocarbon group having 12 or less carbon atoms, preferably a hydrogen atom because of easy availability of the material. Zₐ⁻ represents a counter anion, provided that when a cyanine dye represented by formula (I) has an anionic substituent within the structure and the neutralization of the electric charge is not necessary, Zₐ⁻ is not necessary. Zₐ⁻ preferably represents a halogen ion, a perchlorate ion, a tetrafluoroborate ion, a hexafluorophosphate ion or a sulfonate ion for the storage stability of the recording layer coating solution, and particularly preferably, a perchlorate ion, a hexafluorophosphate ion or an arylsulfonate ion.

As the specific examples of cyanine dyes represented by formula (I) that can be preferably used in the invention, those disclosed in JP-A-2001-133969, paragraphs [0017] to [0019] are exemplified.

Further, as particularly preferred other examples, the indolenine cyanine dyes disclosed in JP-A-2002-278057 are exemplified.

As the pigments which are used in the present invention, commercially available pigments and the pigments described in Color Index (C.I.) Binran (Color Index Bulletin), Saishin Ganryo Binran (The Latest Pigment Handbook), compiled by Nippon Ganryo Gijutsu Kyokai (1977), Saishin Ganryo Oyo Gijutsu (The Latest Pigment Applied Techniques), CMC Publishing Co. Ltd. (1986), Insatsu Ink Gijutsu (Printing Ink Techniques), CMC Publishing Co. Ltd. (1984) can be used.

Various kinds of pigments can be used in the invention, e.g., black pigments, yellow pigments, orange pigments, brown pigments, red pigments, purple pigments, blue pigments, green pigments, fluorescent pigments, metallic powder pigments, and polymer-bond pigments can be exemplified. Specifically, insoluble azo pigments, azo lake pigments, condensation azo pigments, chelate azo pigments, phthalocyanine pigments, anthraquinone pigments, perylene and perinone pigments, thioindigo pigments, quinacridone pigments, dioxazine pigments, isoindolinone pigments, quinophthalone pigments, in-mold lake pigments, azine pigments, nitroso pigments, nitro pigments, natural pigments, fluorescent pigments, inorganic pigments, and carbon black can be used. Of these pigments, carbon black is preferably used.

These pigments can be used without surface treatment or may be surface-treated. As the methods of surface treatments, a method of coating the surfaces of pigments with resins and waxes, a method of adhering surfactants, and a method of bonding reactive substances (e.g., silane coupling agents, epoxy compounds, or polyisocyanate) on the surfaces of pigments can be exemplified. These surface treatment methods are described in Kinzoku Sekken no Seishitsu to Oyo (Natures and Applications of Metal Soaps), Saiwai Shobo Co., Ltd., Insatsu Ink Gijutsu (Printing Ink Techniques), CMC Publishing Co., Ltd. (1984), and Saishin Ganryo Oyo Gijutsu (The Latest Pigment Applied Techniques), CMC Publishing Co., Ltd. (1986).

The particle size of pigments is preferably from 0.01 to 10 μm, more preferably from 0.05 to 1 μm, and particularly preferably from 0.1 to 1 μm. When the particle size of pigments is in this range, stability of the pigment dispersion in an image-recording layer and uniformity of an image-recording layer can be obtained.

Well-know dispersing techniques used in the manufacture of inks and toners can be used as the dispersing methods of pigments. The examples of dispersing apparatus include an ultrasonic disperser, a sand mill, an attritor, a pearl mill, a super-mill, a ball mill, an impeller, a disperser, a KD mill, a colloid mill, a dynatron, a three-roll mill and a pressure kneader, and details are described in Saishin Ganryo Oyo Gijutsu (The Latest Pigment Application Techniques), CMC Publishing Co., Ltd. (1986).

These infrared absorbers may be added to the same layer with other components, or a separate layer may be provided and added thereto. Alternatively, infrared absorbers may be added as the form of being encapsulated in microcapsules.

It is preferred that infrared absorbers are added so that when a negative lithographic printing plate precursor is prepared, the absorbance of an image recording layer at the maximum absorption wavelength in the range of the wavelength of from 760 to 1,200 nm is from 0.3 to 1.2 by reflection measuring method, more preferably from 0.4 to 1.1. In this range of the addition amount, the polymerization reaction proceeds uniformly in the depth direction of the image-recording layer and good layer strength of the image area and the adhesion to the support can be obtained. The absorbance of an image-recording layer can be adjusted by the amount of an infrared absorber added to the image recording layer and the thickness of the image-recording layer. Absorbance can be measured by ordinary methods, e.g., a method of forming an image-recording layer having a thickness in a dry coating weight necessary as the lithographic printing plate on a reflective support, such as an aluminum support, and measuring the reflection density with an optical densitometer, and a method of measuring the absorbance by a reflection method with a spectrophotometer using an integrating sphere are exemplified.

(B) Polymerization Initiator:

A polymerization initiator that can be used in the invention is a compound capable of generating a radical by light or heat, or both energies and initiating and accelerating polymerization of a compound having a polymerizable unsaturated group. As the polymerization initiators that can be used in the invention, well known thermal polymerization initiators, compounds having small bond-dissociating energy, and photopolymerization initiators are exemplified. The polymerization initiators that can be preferably used in the invention are compounds generating radicals by heat energy. The polymerization initiators for use in the invention are specifically described below. The polymerization initiators can be used alone or in combination of two or more.

As such polymerization initiators, e.g., organic halogen compounds, carbonyl compounds, organic peroxides, azo-based polymerization initiators, azide compounds, metallocene compounds, hexaarylbiimidazole compounds, organic boron compounds, disulfone compounds, oxime ester compounds, and onium salt compounds are exemplified.

As the organic halogen compounds, specifically, the compounds described in Wakabayashi et al., Bull. Chem. Soc. Japan, 42, 2924 (1969), U.S. Pat. No. 3,905,815, JP-B-46-4605, JP-A-48-36281, JP-A-53-133428, JP-A-55-32070, JP-A-60-239736, JP-A-61-169835, JP-A-61-169837, JP-A-62-58241, JP-A-62-21240.1, JP-A-63-70243, JP-A-63-298339, and M. P. Hutt, Journal of Heterocyclic Chemistry, 1 (No. 3) (1970) are exemplified. Of these compounds, oxazole compounds substituted with a trihalomethyl group and s-triazine compounds are preferably used.

More preferably, s-triazine derivatives in which at least one mono-, di- or tri-halogen-substituted methyl group is bonded to the s-triazine ring, specifically, e.g., 2,4,6-tris(monochloromethyl)-s-triazine, 2,4,6-tris(dichloro-methyl)-s-triazine, 2,4,6-tris(trichloromethyl)-s-triazine, 2-methyl-4,6-bis(trichloromethyl)-s-triazine, 2-n-propyl-4,6-bis(trichloromethyl)-s-triazine, 2-(α,α,β-trichloro-ethyl)-4,6-bis(trichloromethyl)-s-triazine, 2-phenyl-4,6-bis(trichloromethyl)-s-triazine, 2-(p-methoxyphenyl)-4,6-bis(trichloromethyl)-s-triazine, 2-(3,4-epoxyphenyl)-4,6-bis(trichloromethyl)-s-triazine, 2-(p-chlorophenyl)-4,6-bis(trichloromethyl)-s-triazine, 2-[1-(p-methoxyphenyl)-2,4-butadienyl]-4,6-bis(trichloromethyl)-s-triazine, 2-styryl-4,6-bis (trichloromethyl)-s-triazine, 2-(p-methoxy-styryl)-4,6-bis(trichloromethyl)-s-triazine, 2-(p-1-propyl-oxystyryl)-4,6-bis(trichloromethyl)-s-triazine, 2-(p-tolyl)-4,6-bis(trichloromethyl)-s-triazine, 2-(4-methoxy-naphthyl)-4,6-bis(trichloromethyl)-s-triazine, 2-phenyl-thio-4,6-bis (trichloromethyl)-s-triazine, 2-benzylthio-4,6-bis(trichloromethyl)-s-triazine, 2,4,6-tris (dibromomethyl)-s-triazine, 2,4,6-tris(tribromomethyl)-s-triazine, 2-methyl-4,6-bis(tribromomethyl)-s-triazine, and 2-methoxy-4,6-bis(tribromomethyl)-s-triazine are exemplified.

As the carbonyl compounds, benzophenone derivatives, e.g., benzophenone, Michler's ketone, 2-methylbenzophenone, 3-methylbenzophenone, 4-methylbenzophenone, 2-chlorobenzo-phenone, 4-bromobenzophenone, and 2-carboxybenzophenone, acetophenone derivatives, e.g., 2,2-dimethoxy-2-phenyl-acetophenone, 2,2-diethoxyacetophenone, 1-hydroxycyclohexyl phenyl ketone, α-hydroxy-2-methylphenylpropanone, 1-hydroxy-1-methylethyl-(p-isopropylphenyl) ketone, 1-hydroxy-1-(p-dodecylphenyl) ketone, 2-methyl-[4′-(methylthio)phenyl]-2-morpholino-1-propanone, and 1,1,1-trichloromethyl-(p-butyl-phenyl) ketone, thioxanthone derivatives, e.g., thioxanthone, 2-ethylthioxanthone, 2-isopropylthioxanthone, 2-chloro-thioxanthone, 2,4-dimethylthioxanthone, 2,4-diethylthioxanthone, and 2,4-diisopropylthioxanthone, and benzoic ester derivatives, e.g., ethyl p-dimethylaminobenzoate and ethyl p-diethylaminobenzoate are exemplified.

As the azo compounds, the azo compounds disclosed in JP-A-8-108621 are exemplified.

As the organic peroxides, e.g., trimethylcyclohexanone peroxide, acetylacetone peroxide, 1,1-bis (tert-butylperoxy)-3,3,5-trimethylcyclohexane, 1,1-bis(tert-butylperoxy)cyclo-hexane, 2,2-bis(tert-butylperoxy)butane, tert-butyl hydro-peroxide, cumene hydroperoxide, diisopropylbenzene hydro-peroxide, 2,5-dimethylhexane-2,5-dihydroperoxide, 1,1,3,3-tetramethylbutyl hydroperoxide, tert-butylcumyl peroxide, dicumyl peroxide, 2,5-dimethyl-2,5-di(tert-butylperoxy)-hexane, 2,5-oxanoyl peroxide, succinic acid peroxide, benzoyl peroxide, 2,4-dichlorobenzoyl peroxide, diisopropylperoxy dicarbonate, di-2-ethylhexylperoxy dicarbonate, di-2-ethoxy-ethylperoxy dicarbonate, dimethoxyisopropylperoxy carbonate, di(3-methyl-3-methoxybutyl)peroxy dicarbonate, tert-butyl-peroxy acetate, tert-butylperoxy pivalate, tert-butylperoxy neodecanoate, tert-butylperoxy octanoate, tert-butylperoxy laurate, tersyl carbonate, 3,3′,4,4′-tetra(t-butylperoxy-carbonyl)benzophenone, 3,3′,4,4′-tetra(t-hexylperoxy-carbonyl)benzophenone, 3,3′,4,4′-tetra(p-isopropylcumyl-peroxycarbonyl)benzophenone, carbonyldi(t-butylperoxy-dihydrogendiphthalate), and carbonyldi(t-hexylperoxy-dihydrogendiphthalate) are exemplified.

As the metallocene compounds, various titanocene compounds disclosed in JP-A-59-152396, JP-A-61-151197, JP-A-63-41484, JP-A-2-249, JP-A-2-4705 and JP-A-5-83588, e.g., dicyclopentadienyl-Ti-bis-phenyl, dicyclopentadienyl-Ti-bis-2,6-difluorophen-1-yl, dicyclopentadienyl-Ti-bis-2,4-difluorophen-1-yl, dicyclopentadienyl-Ti-bis-2,4,6-trifluorophen-1-yl, dicyclopentadienyl-Ti-bis-2,3,5,6-tetrafluorophen-1-yl, dicyclopentadienyl-Ti-bis-2,3,4,5,6-pentafluorophen-1-yl, dimethylcyclopentadienyl-Ti-bis-2,6-difluorophen-1-yl, dimethylcyclopentadienyl-Ti-bis-2,4,6-trifluorophen-1-yl, dimethylcyclopentadienyl-Ti-bis-2,3,5,6-tetrafluorophen-1-yl, dimethylcyclopentadienyl-Ti-bis-2,3,4,5,6-pentafluorophen-1-yl, and the iron-arene complexes disclosed in JP-A-1-304453 and JP-A-1-152109 are exemplified.

As the hexaarylbiimidazole compounds, various compounds disclosed in JP-B-6-29285, U.S. Pat. Nos. 3,479,185, 4,311,783 and 4,622,286, specifically, e.g., 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o,p-dichloro-phenyl)-4,4′,5,5′-tetraphenylbiimidazole, 2,2′-bis-(o-chlorophenyl)-4,4′,5,5′-tetra(m-methoxyphenyl)biimidazole, 2,2′-bis(o,o′-dichlorophenyl)-4,4′,5,5′-tetraphenyl-biimidazole, 2,2′-bis(o-nitrophenyl)-4,4′,5,5′-tetraphenyl-biimidazole, 2,2′-bis(o-methylphenyl)-4,4′,5,5′-tetra-phenylbiimidazole, and 2,2′-bis(o-trifluorophenyl)-4,4′,5,5′-tetraphenylbiimidazole are exemplified.

As the organic boron compounds, e.g., the organic borates disclosed in JP-A-62-143044, JP-A-62-150242, JP-A-9-188685, JP-A-9-188686, JP-A-9-188710, JP-A-2000-131837, JP-A-2002-107916, Japanese Patent No. 2764769, JP-A-2002-116539, and Kunz, Martin, “Rad Tech '98 Proceeding Apr. 19-22, 1998, Chicago”, the organic boron sulfonium complexes or the organic boron oxosulfonium complexes disclosed in JP-A-6-157623, JP-A-6-175564 and JP-A-6-175561, the organic boron iodonium complexes disclosed in JP-A-6-175554 and JP-A-6-175553, the organic boron phosphonium complexes disclosed in JP-A-9-188710, and organic boron transition metal coordination complexes disclosed in JP-A-6-348011, JP-A-7-128785, JP-A-7-140589, JP-A-7-306527 and JP-A-7-292014 are exemplified.

As the disulfone compounds, the compounds disclosed in JP-A-61-166544 and JP-A-2003-328465 are exemplified.

As the oxime ester compounds, the compounds described in J. C. S. Perkin II, 1653-1660 (1979), J. C. S. Perkin II, 156-162 (1979), Journal of Photopolymer Science and Technology, 202-232 (1995), JP-A-2000-66385, the compounds disclosed in JP-A-2000-80068, specifically the compounds represented by the following formulae are exemplified.

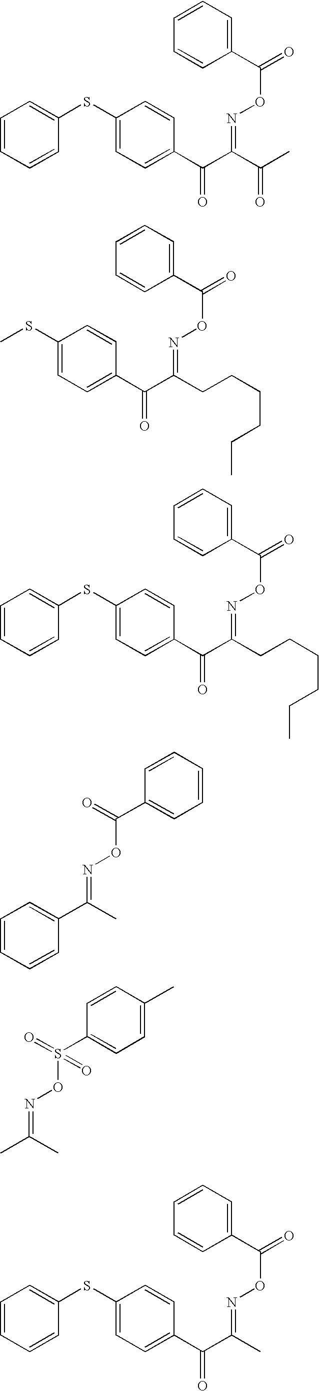

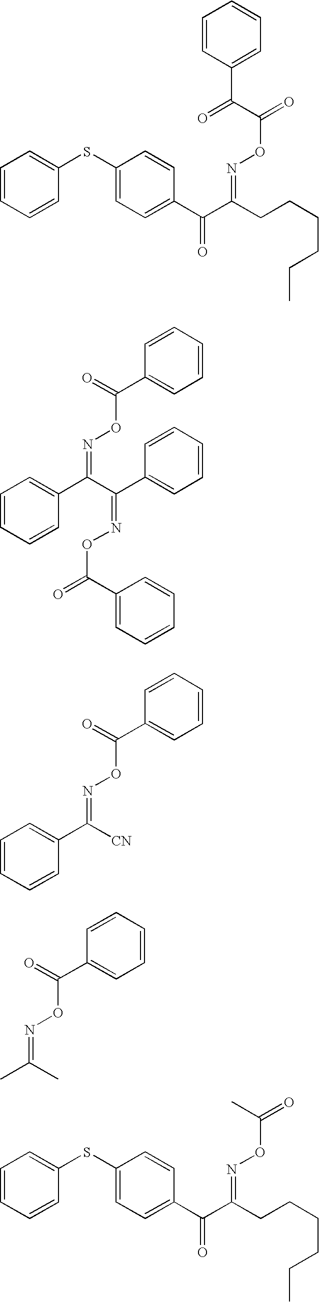

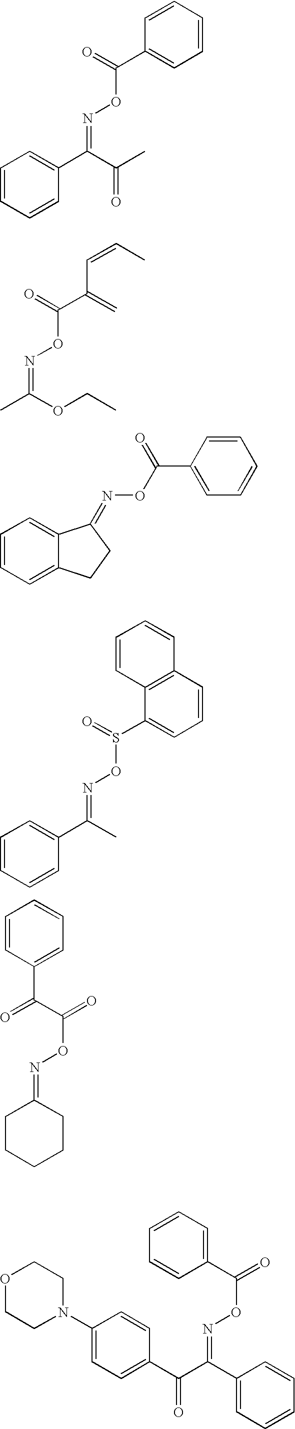

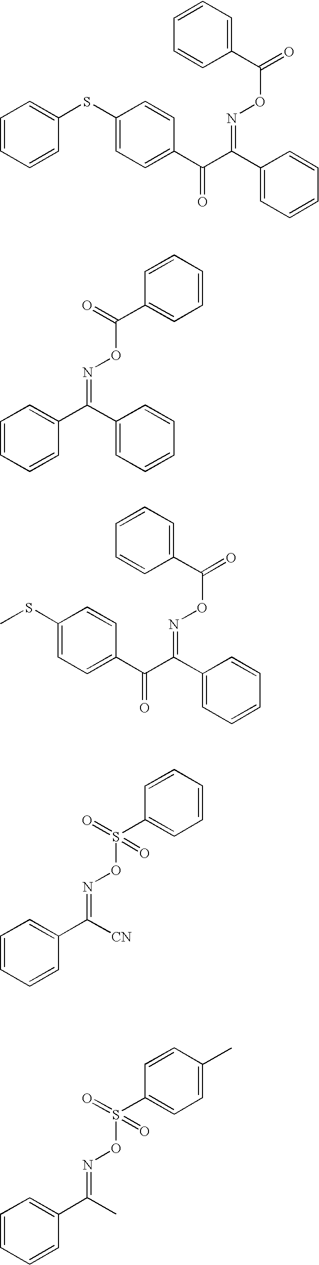

As the onium salt compounds, onium salts, e.g., the diazonium salts described in S. I. Schlesinger, Photogr. Sci. Eng., 18, 387 (1974), and T. S. Bal et al., Polymer, 21, 423 (1980), the ammonium salts disclosed in U.S. Pat. No. 4,069,055 and JP-A-4-365049, the phosphonium salts disclosed in U.S. Pat. Nos. 4,069,055 and 4,069,056, the iodonium salts disclosed in EP 104,143, U.S. Pat. Nos. 339,049, 410,201, JP-A-2-150848 and JP-A-2-296514, the sulfonium salts disclosed in EP 370,693, EP 390,214, EP 233,567, EP 297,443, EP 297,442, U.S. Pat. Nos. 4,933,377, 161,811, 410,201, 339,049, 4,760,013, 4,734,444, 2,833,827, German Patent Nos. 2,904,626, 3,604,580 and 3,604,581, the selenonium salts described in J. V. Crivello et al., Macromolecules, 10 (6), 1307 (1977), and J. V. Crivello et al., J. Polymer Sci., Polymer Chem. Ed., 17, 1047 (1979), and the arsonium salts described in C. S. Wen et al., Teh. Proc. Conf. Rad. Curing ASIA, p. 478, Tokyo, October (1988) are exemplified.

As preferred compounds particularly from the aspects of reactivity and stability, the oxime ester compounds and the onium salts (diazonium salts, iodonium salts and sulfonium salts) are exemplified.

The onium salts preferably used in the invention are onium salts represented by the following formulae (RI-I) to (RI-III).

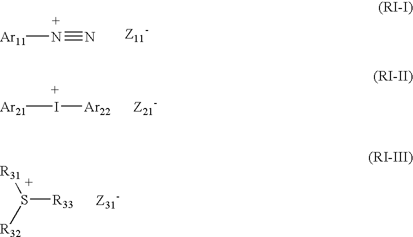

In formula (RI-I), Ar₁₁ represents an aryl group having 20 or less carbon atoms, which may have from 1 to 6 substituents, and as the preferred substituents, an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxyl group having from 1 to 12 carbon atoms, an aryloxy group having from 1 to 12 carbon atoms, a halogen atom, an alkylamino group having from 1 to 12 carbon atoms, a dialkylamino group having from 1 to 12 carbon atoms, an alkylamido group or arylamido group having from 1 to 12 carbon atoms, a carbonyl group, a carboxyl group, a cyano group, a sulfonyl group, a thioalkyl group having from 1 to 12 carbon atoms, and a thioaryl group having from 1 to 12 carbon atoms are exemplified. Z₁₁⁻ represents a monovalent anion, specifically a halogen ion, a perchlorate ion, a hexafluorophosphate ion, a tetrafluoroborate ion, a sulfonate ion, a sulfinate ion, a thiosulfonate ion and a sulfate ion are exemplified. In view of stability, a perchlorate ion, a hexafluorophosphate ion, a tetrafluoro-borate ion, a sulfonate ion and a sulfinate ion are particularly preferred.

In formula (RI-II), Ar₂₁ and Ar₂₂ each independently represents an aryl group having 20 or less carbon atoms, which may have from 1 to 6 substituents, and as the preferred substituents, an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxyl group having from 1 to 12 carbon atoms, an aryloxy group having from 1 to 12 carbon atoms, a halogen atom, an alkylamino group having from 1 to 12 carbon atoms, a dialkylamino group having from 1 to 12 carbon atoms, an alkylamido group or arylamido group having from 1 to 12 carbon atoms, a carbonyl group, a carboxyl group, a cyano group, a sulfonyl group, a thioalkyl group having from 1 to 12 carbon atoms, and a thioaryl group having from 1 to 12 carbon atoms are exemplified. Z₂₁⁻ represents a monovalent anion, specifically a halogen ion, a perchlorate ion, a hexafluoro-phosphate ion, a tetrafluoroborate ion, a sulfonate ion, a sulfinate ion, a thiosulfonate ion and a sulfate ion are exemplified. In view of stability and reactivity, a perchlorate ion, a hexafluorophosphate ion, a tetrafluoro-borate ion, a sulfonate ion, a sulfinate ion and a carboxylate ion are particularly preferred.

In formula (RI-III), R₃₁, R₃₂ and R₃₃ each independently represents an aryl, alkyl, alkenyl or alkynyl group having 20 or less carbon atoms, which may have from 1 to 6 substituents. Above all, in view of stability and reactivity, an aryl group is preferred. As the substituents, an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxyl group having from 1 to 12 carbon atoms, an aryloxy group having from 1 to 12 carbon atoms, a halogen atom, an alkylamino group having from 1 to 12 carbon atoms, a dialkylamino group having from 1 to 12 carbon atoms, an alkylamido group or arylamido group having from 1 to 12 carbon atoms, a carbonyl group, a carboxyl group, a cyano group, a sulfonyl group, a thioalkyl group having from 1 to 12 carbon atoms, and a thioaryl group having from 1 to 12 carbon atoms are exemplified. Z₃₁⁻ represents a monovalent anion, specifically a halogen ion, a perchlorate ion, a hexafluoro-phosphate ion, a tetrafluoroborate ion, a sulfonate ion, a sulfinate ion, a thiosulfonate ion, and a sulfate ion are exemplified. In view of stability and reactivity, a perchlorate ion, a hexafluorophosphate ion, a tetrafluoro-borate ion, a sulfonate ion, a sulfinate ion and a carboxylate ion are particularly preferred. The carboxylate ion disclosed in JP-A-2001-343742 is more preferred, and the carboxylate ion disclosed in JP-A-2002-148790 is particularly preferred.

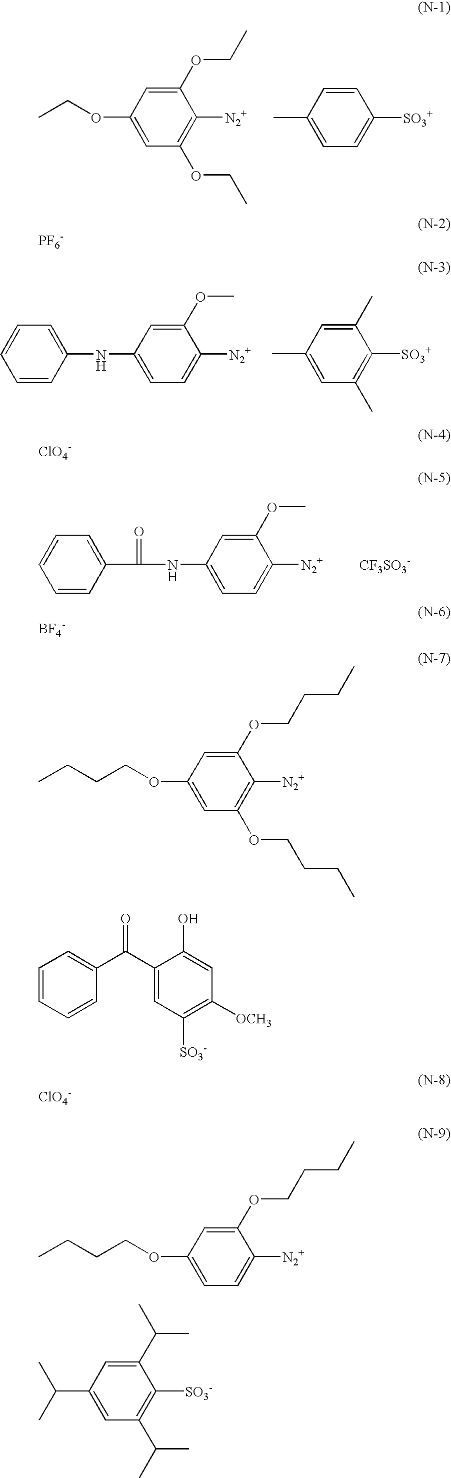

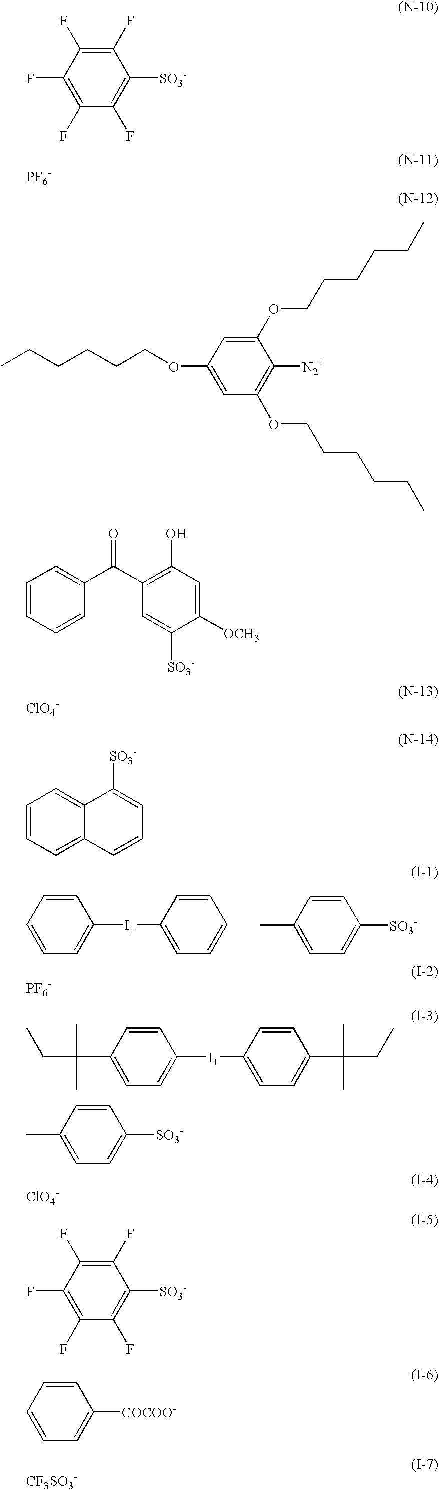

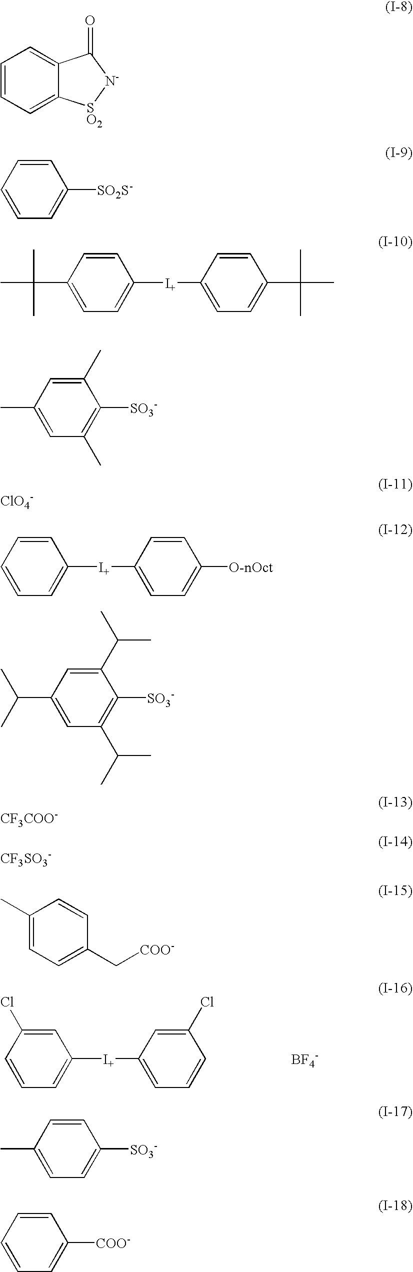

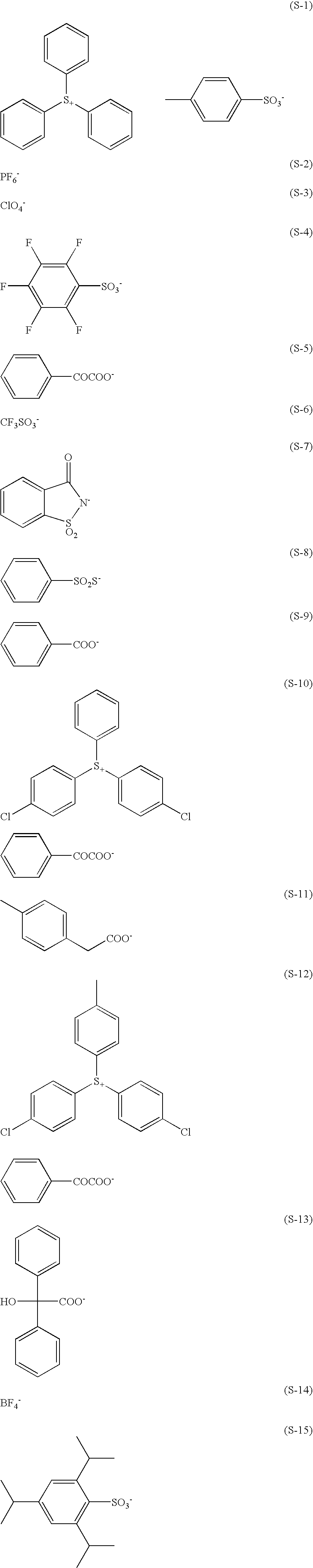

Polymerization initiators can be used in an amount of from 0.1 to 50 weight % to the total solids content constituting an image-recording layer, preferably from 0.5 to 30 weight %, and particularly preferably from 1 to 20 weight %. By using polymerization initiators in this range, good sensitivity and soiling resistance of a non-image area in printing can be obtained. Polymerization initiators may be used alone, or two or more of them may be used in combination. Polymerization initiators may be added to the same layer with other components, or other layer may be provided for polymerization initiators.

(C) Polymerizable Compound:

The polymerizable compounds usable in an image-recording layer in the invention are addition polymerizable compounds having at least one ethylenic unsaturated double bond, and they are selected from the compounds having at least one, preferably two or more, ethylenic unsaturated bond at terminal. These compounds are well known in the field of this industry, and they can be used with no particular limitation in the invention. These polymerizable compounds have chemical forms of, e.g., a monomer, a prepolymer, i.e., a diner, a trimer, an oligomer, and a mixture and a copolymer of them. As the examples of monomers and the copolymers of them, unsaturated carboxylic acids (e.g., acrylic acid, methacrylic acid, itaconic acid, crotonic acid, isocrotonic acid, maleic acid, etc.), and esters and amides of these unsaturated carboxylic acids are exemplified, and preferably esters of unsaturated carboxylic acids and aliphatic polyhydric alcohol compounds, and amides of unsaturated carboxylic acids and aliphatic polyhydric amine compounds are used. In addition, the addition reaction products of esters and amides of unsaturated carboxylic acids having a nucleophilic substituent such as a hydroxyl group, an amino group or a mercapto group with monofunctional or polyfunctional isocyanates or epoxies, and the dehydration condensation reaction products with monofunctional or polyfunctional carboxylic acids are also preferably used. Further, the addition reaction products of unsaturated carboxylic esters or amides having an electrophilic substituent such as an isocyanate group or an epoxy group with monofunctional or polyfunctional alcohols, amines or thiols, and the substitution reaction products of unsaturated carboxylic esters or amides having a separable substituent such as a halogen group or a tosyloxy group with monofunctional or polyfunctional alcohols, amines or thiols are also preferably used. As another example, it is also possible to use compounds in which the unsaturated carboxylic acids are replaced with unsaturated phosphonic acid, styrene, vinyl ether, etc.

The specific examples of monomers of the esters of aliphatic polyhydric alcohol compounds and unsaturated carboxylic acids include, as acrylic esters, ethylene glycol diacrylate, triethylene glycol diacrylate, 1,3-butanediol diacrylate, tetramethylene glycol diacrylate, propyleneglycol diacrylate, neopentyl glycol diacrylate, trimethylol-propane triacrylate, trimethylolpropane tri(acryloyloxy-propyl) ether, trimethylolethane triacrylate, hexanediol diacrylate, 1,4-cyclohexanediol diacrylate, tetraethylene glycol diacrylate, pentaerythritol diacrylate, penta-erythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri (acryloyloxyethyl) isocyanurate, polyester acrylate oligomer, isocyanuric acid EO-modified triacrylate, etc.

As methacrylic esters, the examples include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butane-diol dimethacrylate, hexanediol dimethacrylate, penta-erythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, bis[p-(methacryloxyethoxy)phenyl]dimethylmethane, etc.

As itaconic esters, the examples include ethylene glycol diitaconate, propylene glycol diitaconate, 1,3-butanediol diitaconate, 1,4-butanediol diitaconate, tetramethylene glycol diitaconate, pentaerythritol diitaconate, sorbitol tetraitaconate, etc. As crotonic esters, the examples include ethylene glycol dicrotonate, tetramethylene glycol dicrotonate, pentaerythritol dicrotonate, sorbitol tetradicrotonate, etc. As isocrotonic esters, the examples include ethylene glycol diisocrotonate, pentaerythritol diisocrotonate, sorbitol tetraisocrotonate, etc. As maleic esters, the examples include ethylene glycol dimaleate, triethylene glycol dimaleate, pentaerythritol dimaleate, sorbitol tetramaleate, etc.

As the examples of other esters, e.g., the aliphatic alcohol esters disclosed in JP-B-51-47334 and JP-A-57-196231, the esters having an aromatic skeleton disclosed in JP-A-59-5240, JP-A-59-5241 and JP-A-2-226149, and the esters containing an amino group disclosed in JP-A-1-165613 are also preferably used in the present invention. The above ester monomers can also be used as mixtures.

Further, the specific examples of the amide monomers of aliphatic polyhydric amine compounds and unsaturated carboxylic acids include methylenebis-acrylamide, methylenebis-methacrylamide, 1,6-hexamethylenebis-acrylamide, 1,6-hexamethylenebis-methacrylamide, diethylenetriaminetris-acrylamide, xylylenebis-acrylamide, xylylenebis-methacrylamide, etc. As other preferred amide monomers, those having a cyclohexylene structure disclosed in JP-B-54-21726 can be exemplified.

Further, urethane-based addition polymerizable compounds manufactured by the addition reaction of isocyanate and a hydroxyl group are also preferably used. As the specific examples of such compounds, as disclosed in JP-B-48-41708, a vinyl urethane compound containing two or more polymerizable vinyl groups in one molecule obtained by adding vinyl monomer having a hydroxyl group represented by the following formula (II) to a polyisocyanate compound having two or more isocyanate groups is exemplified.
CH₂═C(R₄)COOCH₂CH(R₅)OH (II)
wherein R₄ and R₅ each independently represents H or CH₃.

The urethane acrylates disclosed in JP-A-51-37193, JP-B-2-32293 and JP-B-2-16765, and the urethane compounds having an ethylene oxide skeleton disclosed in JP-B-58-49860, JP-B-56-17654, JP-B-62-39417 and JP-B-62-39418 are also preferably used in the invention. In addition, extremely high speed photopolymerizable compositions can be obtained by using addition polymerizable compounds having an amino structure and a sulfide structure in the molecule as disclosed in JP-A-63-277653, JP-A-63-260909 and JP-A-1-105238.

As other examples, the polyfunctional acrylates and methacrylates, such as polyester acrylates, and epoxy acrylates obtained by reacting epoxy resins with (meth) acrylic acids as disclosed in JP-A-48-64183, JP-B-49-43191 and JP-B-52-30490 can be exemplified. The specific unsaturated compounds disclosed in JP-B-46-43946, JP-B-1-40337 and JP-B-1-40336, and the vinyl sulfonic acid compounds disclosed in JP-A-2-25493 can also be exemplified. Further, according to cases, the structures containing a perfluoroalkyl group disclosed in JP-A-61-22048 are preferably used. Moreover, the photo-curable monomers and oligomers introduced into Bulletin of Nippon Setchaku Kyokai, Vol. 20, No. 7, pp. 300-308 (1984) can also be used.

The details in usage of these polymerizable compound, e.g., what structure is to be used, whether the compound is to be used alone or in combination, or what an amount is to be used, can be optionally set up according to the final design of the performances of the lithographic printing plate precursor. For example, the conditions are selected from the viewpoint as follows.

In the point of sensitivity, the structure containing many unsaturated groups per a molecule is preferred and bifunctional or higher functional groups are preferred in many cases. For increasing the strength of an image area, i.e., a hardened film, trifunctional or higher functional groups are preferred, and it is also effective to use different functional numbers and different polymerizable groups (e.g., acrylic ester, methacrylic ester, styrene compounds, vinyl ether compounds) in combination to control both speed and strength.

Further, the selection and usage of the addition polymerizable compounds are important factors for the compatibility with other components in an image-recording layer (e.g., a binder polymer, a polymerization initiator, a colorant) and dispersibility, for example, in some cases compatibility can be improved by using low purity compounds or two or more compounds in combination. Further, it is also possible to select a compound having a specific structure for the purpose of improving the adhesion property to a support and an overcoat layer described later.

Polymerizable compounds are used preferably in an amount of from 5 to 80 weight % to the non-volatile components in an image-recording layer, and more preferably from 25 to 75 weight %. Polymerizable compounds may be used alone, or two or more compounds may be used in combination. In addition, the structure, the blending method and the addition amount of polymerizable compounds can be properly selected in view of the degree of polymerization hindrance by oxygen, resolution, a fogging property, refractive index change and surface stickiness and, further, in some cases, layer constitution and coating method of undercoating and upper coating may be taken.

Microcapsule:

In the present invention, by adding microcapsules in an image-recording layer, rough structure can be formed on the surface of the image-recording layer, whereby the dynamic friction coefficient of an interleaving sheet and the surface of the image-recording layer can be controlled.

The average particle size of microcapsules is preferably from 0.01 to 3.0 μm, more preferably from 0.05 to 2.0 μm, and particularly preferably from 0.10 to 1.0 μm. Good dynamic friction coefficient, resolution and aging stability can be obtained with this range of particle size.

As the materials to be encapsulated in microcapsules, any of the above (A) an infrared absorber, (B) a polymerization initiator, (C) a polymerizable compound, and other additives that can be added to an image-recording layer such as a colorant and a print out agent described later can be encapsulated, but it is preferred to encapsulate low molecular weight components that raise the dynamic friction coefficient in microcapsules. It is more preferred to encapsulate at least one of (A) an infrared absorber, (B) a polymerization initiator, and (C) a polymerizable compound in microcapsules, in particular, many (C) polymerizable compounds have fluidity at room temperature, accordingly encapsulation of (C) a polymerizable compound is most preferred.

An amount of the materials to be encapsulated may be a part of a necessary amount for an image-recording layer, or may be a whole thereof. With respect to a dynamic friction coefficient, in particular, in case of encapsulating low molecular weight components, an encapsulated ratio thereof is preferred to be high.

A shape of microcapsules may be a core-shell structure where the materials to be encapsulated is completely separated from the microcapsule walls, or the materials to be encapsulated may be compatible with and comprised in the microcapsule walls. With respect to a dynamic friction coefficient, a core-shell structure is preferred, because the separation of low molecular weight components certainly occurs.

By using microcapsules as above, both effects of surface roughening of an image-recording layer and encapsulation of low molecular weight components can be obtained, so that it becomes possible to control the dynamic friction coefficient to a low level while securing the necessary amount of low molecular weight components in an image-recording layer.

Constitutional components of an image-recording layer can be microencapsulated by well known methods. For example, as the manufacturing method of microcapsules, the method making use of coacervation as disclosed in U.S. Pat. Nos. 2,800,457 and 2,800,458, the interfacial polymerization method as disclosed in U.S. Pat. No. 3,287,154, JP-B-38-19574 and JP-B-42-446, the method by the precipitation of a polymer as disclosed in U.S. Pat. Nos. 3,418,250 and 3,660,304, the method of using isocyanate polyol wall materials as disclosed in U.S. Pat. No. 3,796,669, the method of using isocyanate wall materials as disclosed in U.S. Pat. No. 3,914,511, the method of using urea-formaldehyde series or urea-formaldehyde-resorcinol series wall materials as disclosed in U.S. Pat. Nos. 4,001,140, 4,087,376 and 4,089,802, the method of using melamine-formaldehyde resins and hydroxy cellulose wall materials as disclosed in U.S. Pat. No. 4,025,445, the monomer polymerization in situ method as disclosed in JP-B-36-9163 and JP-B-51-9079, the spray drying method as disclosed in British Patent 930,422 and U.S. Pat. No. 3,111,407, and the electrolytic dispersion cooling method as disclosed in British Patents 952,807 and 967,074 can be exemplified, but the present invention is not limited to these methods.

The microcapsule walls preferably used in the invention have three dimensional crosslinking and a property of swelling by a solvent. From this point of view, polyurea, polyurethane, polyester, polycarbonate, polyamide, and the mixtures of these compounds are preferably used as the microcapsule wall materials, and polyurea and polyurethane are particularly preferred. Compounds having crosslinkable functional groups such as ethylenic unsaturated bonds that can be used in binder polymers as described later may be introduced into microcapsule walls. Other components of image-recording layer:

In addition to the above components, various additives such as inorganic fine particles, a sliding agent, a binder polymer, a surfactant, a colorant, a print out agent, a polymerization inhibitor, a higher fatty acid derivative, a plasticizer, and a low molecular weight hydrophilic compound can be added to the image-recording layer of the present invention, if necessary. These additives are described below.

Inorganic Fine Particles:

By the addition of inorganic fine particles to an image recording layer, surface roughening structure can be formed on the surface of the image recording layer, whereby the dynamic friction coefficient of an interleaving sheet and the image-recording layer can be controlled, so that inorganic fine particles are particularly useful additive. When a great amount of low molecular weight polymerizable compounds are contained and the surface of the image-recording layer is sticky, inorganic fine particles are particularly efficacious. The addition of inorganic fine particles reduces the contact area of the image-recording layer and the interleaving sheet. Introducing air between the image-recording layer and the interleaving sheet has the effect of decreasing the dynamic friction coefficient.

Further, inorganic fine particles contribute to the improvement of the layer strength of an exposed area and the on-press developing property of an unexposed area.

As inorganic fine particles, e.g., silica, alumina, magnesium oxide, titanium oxide, magnesium carbonate, calcium alginate and mixtures of these fine particles are preferably used.

The average particle size of inorganic fine particles is preferably from 0.1 to 10 μm, more preferably from 0.1 to 3 μm. With this range of the average particle size, inorganic fine particles are stably dispersed in an image-recording layer, a surface roughness structure of the image-recording layer surface can be formed, and the layer strength of the image recording layer can be improved, so that a non-image area difficult to be soiled and excellent in hydrophilicity can be formed.

These inorganic fine particles are easily available as commercial products of colloidal silica dispersion and the like.

The addition amount of inorganic fine particles is preferably 40 weight % or less to the solids content of the image-recording layer, more preferably 30 weight % or less.

Sliding Agent:

A sliding agent can be added to the image-recording layer of the present invention. As such sliding agents, well known sliding agents, e.g., nonionic surfactants and ampholytic surfactants containing fluorine atoms and silicon atoms, and waxes are exemplified. Further, it is also possible to control the dynamic friction coefficient by adding compounds having long chain alkyl groups showing orientation on the surface of an image-recording layer to an image-recording layer coating solution. By adding the compound represented by formula (1) disclosed in JP-A-2002-296768, the dynamic friction coefficient can also be controlled. By the selection of each kind of these additives and adjusting the addition amount, the dynamic friction coefficient can be easily controlled. However, when the amount of sliding agents is too high, the dynamic friction coefficient of the image-recording layer and the interleaving sheet becomes too small and the carrying property may be impaired. Accordingly, a sliding agent is used at the rate of preferably from 0.05 to 8.0 weight % to all the solids content constituting an image-recording layer, and more preferably from 0.1 to 7.0 weight %.

Binder Polymer:

A binder polymer can be used in the image-recording layer in the invention. The binder polymer is not particularly restricted and any well known compounds can be used, and polymers having a film-forming property are preferably used. The examples of such binder polymers include acrylic resins, polyvinyl acetal resins, polyurethane resins, polyurea resins, polyimide resins, polyamide resins, epoxy resins, methacrylic resins, polystyrene resins, novolak type phenolic resins, polyester resin, synthetic rubber and natural rubber.

Binder polymers may have a crosslinking property to improve the layer strength of an image area. For giving a crosslinkable property to binder polymers, it is effective to introduce a crosslinkable functional group such as an ethylenic unsaturated bond into the main chain or side chain of the binder polymers. A crosslinkable functional group may be introduced by copolymerization.

As the examples of the polymers having an ethylenic unsaturated bond in the main chain of the molecule, poly-1,4-butadiene and poly-1,4-isoprene are exemplified.

As the examples of the polymers having an ethylenic unsaturated bond in the side chain of the molecule, polymers of esters or amides of acrylic acid or methacrylic acid, wherein the residue of the ester or amide (R of —COOR or —CONHR) has an ethylenic unsaturated bond are exemplified.

As the examples of the residues having an ethylenic unsaturated bond (the above-described R), —(CH₂)ₙCR¹═CR²R³, —(CH₂O)ₙCH₂CR¹═CR²R³, —(CH₂CH₂O)ₙCH₂CR¹═CR²R³—(CH₂)ₙNH—CO—O—CH₂CR¹=CR²R³, —(CH₂)ₙ—O—CO—CR¹═CR²R³ and (CH₂CH₂O)₂—X (wherein R¹, R² and R³ each independently represents a hydrogen atom, a halogen atom, an alkyl group having from 1 to 20 carbon atoms, an aryl group, an alkoxyl group or an aryloxy group, and R¹ and R² or R³ may be bonded to each other to form a ring, n represents an integer of from 1 to 10, and X represents a dicyclopentadienyl residue) are exemplified.

As the specific examples of ester residues, —CH₂CH═CH₂ (disclosed in JP-B-7-21633), —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and CH₂CH₂O—X (wherein X represents a dicyclopentadienyl residue) are exemplified.

As the examples of amido residues, —CH₂CH═CH₂, —CH₂CH₂—Y (wherein Y represents a cyclohexene residue), and —CH₂CH₂—OCO—CH═CH₂ are exemplified.

When free radicals (polymerization initiation radicals or the grown radicals of a polymerizable compound in the polymerization process) are added to the crosslinkable functional groups of a binder polymer having a crosslinking property, addition polymerization occurs directly between the polymers or via the polymerization chains of the polymerizable compound, as a result, crosslinking is formed between the molecules of the polymers and the binder polymer is hardened. Alternatively, the atoms in the polymer (e.g., the hydrogen atoms on the carbon atoms contiguous to crosslinkable functional groups) are extracted by free radicals and polymer radicals are grown, the polymer radicals are bonded to each other, whereby crosslinking is formed between the polymer molecules, so that the binder polymer is hardened.

The amount of crosslinkable groups contained in a binder polymer (the amount contained of radical polymerizable unsaturated double bonds by the iodometric titration method) is preferably from 0.1 to 10.0 mmol per gram of the binder polymer, more preferably from 1.0 to 7.0 mmol, and most preferably from 2.0 to 5.5 mmol. Good sensitivity and good storage stability can be obtained with this range of crosslinkable groups.

From the viewpoint of the improvement of the on-press developing property of the unexposed area of an image-recording layer, it is preferred that binder polymers have high solubility and dispersibility in ink and/or a fountain solution.

For improving the solubility and dispersibility in ink, binder polymers are preferably lipophilic, and for improving the solubility and dispersibility in a fountain solution, binder polymers are preferably hydrophilic. Accordingly, in the present invention, it is also effective to use a lipophilic binder polymer and a hydrophilic binder polymer in combination.

As hydrophilic binder polymers, binder polymers having a hydrophilic group, e.g., a hydroxyl group, a carboxyl group, a carboxylate group, a hydroxyethyl group, a polyoxyethyl group, a hydroxypropyl group, a polyoxypropyl group, an amino group, an aminoethyl group, an aminopropyl group, an ammonium group, an amido group, a carboxymethyl group, a sulfonic acid group and a phosphoric acid group are preferably exemplified.

The specific examples of hydrophilic binder polymers include gum arabic, casein, gelatin, starch derivatives, carboxymethyl cellulose and the sodium salt of it, cellulose acetate, sodium alginate, vinylacetate-maleic acid copolymers, styrene-maleic acid copolymers, polyacrylic acids and the salts of them, polymethacrylic acids and the salts of them, homopolymers and copolymers of hydroxyethyl methacrylate, homopolymers and copolymers of hydroxyethyl acrylate, homopolymers and copolymers of hydroxypropyl methacrylate, homopolymers and copolymers of hydroxypropyl acrylate, homopolymers and copolymers of hydroxybutyl methacrylate, homopolymers and copolymers of hydroxybutyl acrylate, polyethylene glycols, hydroxypropylene polymers, polyvinyl alcohols, hydrolyzed polyvinyl acetate having a hydrolysis degree of 60 mol % or more, preferably 80 mol % or more, polyvinyl formal, polyvinyl butyral, polyvinyl pyrrolidone, homopolymers and copolymers of acrylamide, homopolymers and copolymers of methacrylamide, homopolymers and copolymers of N-methylolacrylamide, polyvinyl pyrrolidone, alcohol-soluble nylon, and polyether of 2,2-bis (4-hydroxy-phenyl)propane and epichlorohydrin.

Binder polymers preferably have a weight average molecular weight of preferably 5,000 or higher, more preferably from 10,000 to 300,000, and a number average molecular weight of preferably 1,000 or higher, more preferably from 2,000 to 250,000. The polydisperse degree (weight average molecular weight/number average molecular weight) is preferably from 1.1 to 10.

The above binder polymers may be any of a random polymer, a block polymer and a graft polymer, but a random polymer is preferred.

These binder polymers can be synthesized by well known methods. As the solvents for use in the synthesis, e.g., tetrahydrofuran, ethylene dichloride, cyclohexanone, methyl ethyl ketone, acetone, methanol, ethanol, ethylene glycol monomethyl ether, ethylene glycol monoethyl ether, 2-methoxyethyl acetate, diethylene glycol dimethyl ether, 1-methoxy-2-propanol, 1-methoxy-2-propyl acetate, N,N-dimethylformamide, N,N-dimethylacetamide, toluene, ethyl acetate, methyl lactate, ethyl lactate, dimethyl sulfoxide, and water are exemplified. These solvents may be used alone or two or more solvents may be used as a mixture.

As the radical polymerization initiators used in the synthesis of binder polymers, well known compounds, e.g., azo initiators and peroxide initiators can be used.

Binder polymers may be used alone or as a mixture of two or more.

Binder polymers are used in an amount of from 5 to 90 weight % to the total solids content of the image-forming layer, preferably from 5 to 80 weight %, and more preferably from 10 to 70 weight %. When binder polymers are used in this range, preferred strength of an image area and good image-forming property can be obtained.

It is preferred to use (C) polymerizable compound and a binder polymer in weight ratio of from 1/2 to 7/2.

Surfactant:

In the present invention, it is preferred to use a surfactant in an image-recording layer to accelerate the on-press development property at the time of initiating printing and to improve the conditions of coating surface. As the surfactants for these purposes, nonionic surfactants, anionic surfactants, cationic surfactants, ampholytic surfactants and fluorine surfactants are used. Surfactants may be used alone or two or more surfactants may be used in combination.

The nonionic surfactants for use in the invention are not particularly restricted and conventionally well known surfactants can be used, e.g., polyoxyethylene alkyl ethers, polyoxyethylene alkyl phenyl ethers, polyoxyethylene polystyryl phenyl ethers, polyoxyethylene polyoxypropylene alkyl ethers, glycerol fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerol fatty acid partial esters, polyoxyethylenated castor oils, polyoxyethylene glycerol fatty acid partial esters, fatty acid diethanolamides, N,N-bis-2-hydroxyalkylamines, polyoxyethylene alkylamine, triethanolamine fatty acid esters, trialkylamine oxide, polyethylene glycol, and copolymers of polyethylene glycol and polypropylene glycol are exemplified.

The anionic surfactants for use in the invention are not particularly restricted and conventionally well known surfactants can be used, e.g., fatty acid salts, abietates, hydroxyalkanesulfonates, alkanesulfonates, dialkylsulfosuccinic esters, straight chain alkylbenzenesulfonates, branched chain alkylbenzenesulfonates, alkylnaphthalene-sulfonates, alkylphenoxy polyoxyethylene propyl sulfonates, polyoxyethylene alkyl sulfophenyl ethers, sodium N-methyl-N-oleyltaurine, disodium N-alkylsulfosuccinic acid monoamide, petroleum sulfonates, sulfated beef tallow, sulfuric esters of fatty acid alkyl ester, alkylsulfuric esters, polyoxyethylene alkyl ether sulfuric esters, fatty acid monoglyceride sulfuric esters, polyoxyethylene alkyl phenyl ether sulfuric esters, polyoxyethylene styryl phenyl ether sulfuric esters, alkyl phosphoric esters, polyoxyethylene alkyl ether phosphoric esters, polyoxyethylene alkyl phenyl ether phosphoric esters, partial saponification products of styrene/maleic anhydride copolymers, partial saponification products of olefin/maleic anhydride copolymers, and naphthalene sulfonate formaldehyde condensation products are exemplified.

The cationic surfactants for use in the invention are not particularly restricted and conventionally well known surfactants can be used, e.g., alkylamine salts, quaternary ammonium salts, polyoxyethyene alkylamine salts, and polyethylene polyamine derivatives are exemplified.

The ampholytic surfactants for use in the invention are not particularly restricted and conventionally well known surfactants can be used, e.g., carboxybetaines, amino-carboxylic acids, sulfobetaines, aminosulfuric esters and imidazolines are exemplified.

In the above surfactants, “polyoxyethylene” can be taken as “polyoxyalkylene” such as polyoxymethylene, polyoxy-propylene, and polyoxybutylene, and these surfactants can also be used in the invention.

As more preferred surfactants, fluorine surfactants containing a perfluoroalkyl group in the molecule are exemplified. As such surfactants, anionic surfactants, e.g., perfluoroalkylcarboxylate, perfluoroalkylsulfonate, and perfluoroalkylphosphate; ampholytic surfactants, e.g., perfluoroalkylbetaine; cationic surfactants, e.g., perfluoroalkyltrimethylammonium salt; and nonionic surfactants, e.g., perfluoroalkylamine oxide, perfluoroalkyl ethylene oxide addition products, oligomers containing a perfluoroalkyl group and a hydrophilic group, oligomers containing a perfluoroalkyl group and a lipophilic group, oligomers containing a perfluoroalkyl group, a hydrophilic group, and a lipophilic group, and urethane containing a perfluoroalkyl group and a lipophilic group are exemplified. Further, the fluorine surfactants disclosed in JP-A-62-170950, JP-A-62-226143 and JP-A-60-168144 are also preferably used.

Surfactants can be used alone, or two or more surfactants can be used in combination.

Surfactants are preferably used in an amount of from 0.001 to 10 weight % to all the solids content of the image recording layer, more preferably from 0.01 to 7 weight %.

Colorant:

Further, if necessary, various compounds besides the above compounds can be used in the present invention. For example, dyes having large absorption in the visible ray region can be used as the colorants of images. Specifically, Oil Yellow #101, Oil Yellow #103, Oil Pink #312, Oil Green BG, Oil Blue BOS, Oil Blue #603, Oil Black BY, Oil Black BS, Oil Black T-505 (products of Orient Chemical Industry Co., Ltd.), Victoria Pure Blue, Crystal Violet (C.I. 42555), Methyl Violet (C.I. 42535), Ethyl Violet, Rhodamine B (C.I. 145170B), Malachite Green (C.I. 42000), Methylene Blue (C.I. 52015), and the dyes disclosed in JP-A-62-293247 can be exemplified. In addition, pigments such as phthalocyanine pigments, azo pigments, carbon black and titanium oxide are also preferably used.

These colorants are preferably added to discriminate an image area from a non-image area after image formation. The addition amount of colorants is preferably from 0.01 to 10 weight % to all the solids content of the image recording layer.

Polymerization Inhibitor:

For preventing unnecessary thermal polymerization of (C) radical polymerizable compound during manufacture or preservation of an image-recording layer, it is preferred that a small amount of thermal polymerization inhibitor be added in the invention.

As the thermal polymerization inhibitors, e.g., hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol), and N-nitroso-N-phenylhydroxylamine aluminum salt are exemplified.

The amount of the thermal polymerization inhibitor to be added to an image-recording layer is preferably from about 0.01 to about 5 weight % to all the solids content of the image recording layer.

Higher Fatty Acid Derivatives and the Like:

For preventing the polymerization hindrance due to oxygen, higher fatty acid derivatives, e.g., behenic acid and behenic acid amide, may be added to an image-recording layer in the invention and locally exist on the surface of the image-recording layer in the drying process after coating. The addition amount of the higher fatty acid derivatives is preferably from about 0.1 to about 10 weight % to the total solids content of the image-recording layer.

Plasticizer:

An image-recording layer in the present invention may contain a plasticizer to improve an on-press developing property.

The examples of plasticizers include phthalic esters, e.g., dimethylphthalate, diethylphthalate, dibutylphthalate, diisobutylphthalate, dioctylphthalate, octylcaprylphthalate, dicyclohexyl phthalate, ditridecyl phthalate, butylbenzyl phthalate, diisodecylphthalate, and diallylphthalate; glycol esters, e.g., dimethyl glycol phthalate, ethyl phthalyl ethyl glycolate, methyl phthalyl ethyl glycolate, butyl phthalyl butyl glycolate, and triethylene glycol dicaprylate; phosphoric esters, e.g., tricresyl phosphate and triphenyl phosphate; aliphatic dibasic acid esters, e.g., diisobutyl adipate, dioctyl adipate, dimethyl sebacate, dibutyl sebacate, dioctyl azelate, and dibutyl maleate; and polyglycidyl methacrylate, triethyl citrate, glycerol triacetyl ester and butyl laurate.

The amount of plasticizers is preferably about 30 weight % or less to all the solids content of the image recording layer.

Low Molecular Weight Hydrophilic Compound:

For the improvement of an on-press developing property, an image-recording layer in the invention may contain hydrophilic low molecular weight compounds. As the hydrophilic low molecular weight compounds, water-soluble organic compounds, such as glycols, e.g., ethylene glycol, diethylene glycol, triethylene glycol, propylene glycol, dipropylene glycol, tripropylene glycol, and ether or ester derivatives of these glycols, polyhydroxies, e.g., glycerol and pentaerythritol, organic amines, e.g., triethanolamine, diethanolamine and monoethanolamine, and salts of these organic amines, organic sulfonic acids, e.g., toluenesulfonic acid and benzenesulfonic acid, and salts of these organic sulfonic acids, organic phosphonic acids, e.g., phenyl-phosphonic acid, and salts of phenylphosphonic acid, and organic carboxylic acids, e.g., tartaric acid, oxalic acid, citric acid, malic acid, lactic acid, gluconic acid and amino acid, and salts of these organic carboxylic acids are exemplified.

Formation of Image-Recording Layer:

An image-recording layer in the invention is formed by coating a coating solution prepared by dispersing or dissolving each necessary component in a solvent. As the solvents used here, ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethyl sulfoxide, sulforan, γ-butyrolactone, toluene, and water are exemplified, but solvents are not limited thereto. These solvents are used alone or as mixture. The concentration of the solid contents of the coating solution is preferably from 1 to 50 weight %.

It is also possible to form an image-recording layer in the invention by preparing a plurality of coating solutions by dispersing or dissolving the same or different components in the same or different solvents, and repeating the coating and drying a plurality of times.

The coating amount of an image-forming layer (solids content) obtained on a support after drying is generally preferably from 0.3 to 3.0 g/m², although it differs depending upon the usage. Good sensitivity and good layer strength can be obtained in this range of coating amount.

Various coating methods can be used, e.g., bar coating, rotary coating, spray coating, curtain coating, dip coating, air knife coating, blade coating, and roll coating can be used.

Support:

The support for use in the lithographic printing plate precursor of the invention is an aluminum support subjected to surface roughening treatment.

Aluminum plates are a pure aluminum plate, an alloy plate containing aluminum as a main component and a trace amount of different elements, and aluminum or aluminum alloy thin films laminated with plastics. The examples of different elements contained in aluminum alloys include silicon, iron, manganese, copper, magnesium, chromium, zinc, bismuth, nickel, titanium, etc. The different element content in aluminum alloys is preferably 10 weight % or less. In the present invention, a pure aluminum plate is preferred but 100% pure aluminum is difficult to produce from the refining technique, accordingly, an extremely small amount of different elements may be contained. Thus, the compositions of aluminum plates used in the invention are not specified, and aluminum plates of conventionally well known and commonly used materials can be optionally used.

A support for use in the invention has a thickness of preferably from 0.1 to 0.6 mm, more preferably from 0.15 to 0.4 mm.

Prior to surface roughening treatment of an aluminum plate, if necessary, degreasing treatment with a surfactant, anorganic solvent or an alkaline aqueous solution is carried out to remove the rolling oil on the surface of an aluminum plate.

Surface roughening treatment of the surface of an aluminum plate is performed by various methods, e.g., mechanical surface roughening treatment, electrochemical surface roughening treatment (surface roughening treatment of electrochemically dissolving the surface), and chemical surface roughening treatment (surface roughening treatment of selectively chemically dissolving the surface) are exemplified.

As the method of mechanical surface roughening treatment, well known methods, e.g., a ball rubbing method, a brush abrading method, a blast abrading method, and a buffing method can be used.

As the method of electrochemical surface roughening treatment, a method of roughening an aluminum plate in an electrolyte containing an acid such as a hydrochloric acid or a nitric acid by alternating current or direct current can be used. Further, a method of using mixed acids as disclosed in JP-A-54-63902 can be used.

An aluminum plate subjected to surface roughening treatment is, if necessary, subjected to alkali etching treatment with an aqueous solution of potassium hydroxide or sodium hydroxide and neutralizing treatment and then, if desired, to anodizing treatment to increase the abrasion resistance.

Various electrolytes for forming porous oxide film can be used in the anodizing treatment of an aluminum plate, and sulfuric acid, hydrochloric acid, oxalic acid, chromic acid and mixed acids of these acids are generally used. The concentrations of these electrolytes are arbitrarily determined according to the kinds of electrolytes.

Anodizing treatment conditions vary according to electrolytes used and cannot be specified unconditionally, but in general the appropriate concentration of electrolyte is from 1 to 80 weight % solution, the liquid temperature is from 5 to 70° C., the electric current density is from 5 to 60 A/dm², the voltage is from 1 to 100 V, electrolytic time is from 10 seconds to 5 minutes. The amount of the anodized oxide film formed is preferably from 1.0 to 5.0 g/m², more preferably from 1.5 to 4.0 g/m². With this range of the amount of the anodized oxide film, good press life and the scratch resistance of the non-image area of a lithographic printing plate can be obtained.

As the supports for use in the invention, supports subjected to surface treatments as above and having an anodized oxide film may be used as they are, but for further improving the adhesion with the upper layer, a hydrophilic property, soiling resistance and a heat insulating property, enlarging treatment of the micro-pores of the anodized oxide film, sealing treatment of the micro-pores, and hydrophilization treatment of the surface by immersion in an aqueous solution containing a hydrophilic compound as disclosed in JP-A-2001-253181 and JP-A-2001-322365 can be arbitrarily performed, if necessary.

As the hydrophilization treatment, alkali metal silicate methods as disclosed in U.S. Pat. Nos. 2,714,066, 3,181,461, 3,280,734 and 3,902,734 are known. These are methods of treatment by immersing a support in an aqueous solution of sodium silicate, or electrolytically treating. Besides these methods, a method of treating a support with a potassium fluorozirconate as disclosed in JP-B-36-22063, and a method of treating a support with a polyvinyl phosphonic acid as disclosed in U.S. Pat. Nos. 3,276,868, 4,153,461 and 4,689,272 are exemplified.

A support preferably has central line average surface roughness of from 0.10 to 1.2 μm. With this range of surface roughness, good adhesion of a support with an image-recording layer, good press life and good soiling resistance can be obtained.

Back Coat Layer:

After surface treatment of a support or after forming an undercoat layer, if necessary, a back coat can be provided on the back surface of the support.

As the back coat, e.g., coating layers comprising organic polymer compounds as disclosed in JP-A-5-45885, and coating layers comprising metallic oxides obtained by hydrolysis and polycondensation of organic or inorganic metallic compounds as disclosed in JP-A-6-35174 are preferably used. Alkoxy compounds of silicon, e.g., Si(OCH₃)₄, Si(OC₂H₅)₄, Si(OC₃H₇)₄, Si(OC₄H₉)₄, etc., are preferably used for the inexpensiveness and easy availability of the materials.

Undercoat Layer:

In a lithographic printing plate precursor in the invention, if necessary, an undercoat layer can be provided between an image-recording layer and a support. Since the undercoat layer functions as a heat insulating layer, the heat generated by infrared laser exposure does not diffuse to the support and is efficiently utilized, so that the improvement of sensitivity can be contrived. Further, the image-recording layer comes to be easily peeled off the support at an unexposed area, so that the on-press developing property is improved.

As the undercoat layer, specifically the silane coupling agent having an addition polymerizable ethylenic double bond reactive group disclosed in JP-A-10-282679, and the phosphorus compounds having an ethylenic double bond reactive group are preferred.

The coating amount of an undercoat layer (solids content) is preferably from 0.1 to 100 mg/m², more preferably from 3 to 30 mg/m².

Protective Layer:

For preventing the generation of scratches on an image recording layer, for shielding oxygen, and for preventing ablation at the time of exposure with high intensity laser, if necessary, a protective layer may be provided on an image recording layer of the lithographic printing plate precursor of the present invention.

Exposure is generally performed in the air in the present invention, and the protective layer prevents the mixture of low molecular weight compounds such as oxygen and basic substance in the air that hinder the image forming reaction generated in the image-recording layer by exposure into the image recording layer, by which the hindrance of the image-forming reaction by exposure in the air can be prevented. Accordingly, the characteristics required of the protective layer are to be low in permeability of low molecular weight compounds such as oxygen, good in transmission of light used for exposure, excellent in adhesion with an image-recording layer, and capable of being removed easily by on-press development after exposure. Protective layers having such characteristics have so far been variously examined and they are disclosed in detail, e.g., in U.S. Pat. No. 3,458,311 and JP-B-55-49729.

As the materials that are used for the protective layer, for example, water-soluble polymer compounds relatively excellent in crystallizability are exemplified. Specifically, water-soluble polymers, e.g., polyvinyl alcohol, polyvinyl pyrrolidone, acid celluloses, gelatin, gum arabic, and polyacrylic acid are exemplified. Above all, when polyvinyl alcohol (PVA) is used as the main component, the best results can be given to the fundamental characteristics such as an oxygen-shielding property and the removal by development. Polyvinyl alcohols may be partially substituted with ester, ether or acetal, or may partially contain other copolymer component so long as they contain an unsubstituted vinyl alcohol unit for imparting an oxygen-shielding property and solubility in water that are necessary to the protective layer.

As the specific examples of polyvinyl alcohols, those having a hydrolyzed rate of from 71 to 100 mol % and the degree of polymerization of from 300 to 2,400 are exemplified. Specifically, PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613, and L-8 (manufactured by Kuraray Co., Ltd.) are exemplified.

The components of the protective layer (the selection of PVA, the use of additives, etc.), and the coating amounts are suitably selected by considering fogging characteristic, adhesion and scratch resistance besides the oxygen shielding property and the removal by development. In general, the higher the hydrolyzing rate of PVA (that is, the higher the unsubstituted vinyl alcohol unit content in the protective layer), and the higher the layer thickness, the higher is the oxygen-shielding property, thus advantageous in the point of sensitivity. For the prevention of the generation of unnecessary polymerization reaction during manufacture and storage, or the generation of unnecessary fog and thickening of image lines at image exposure, it is preferred that an oxygen-permeating property is not too high. Therefore, oxygen permeability A at 25° C. under 1 atm is preferably, 0.2≦A≦20 (ml/m²·day).

As other components of the protective layer, glycerol, dipropylene glycol and the like can be added in an amount of several weight % to the (co)polymers to provide flexibility, and further, anionic surfactants, e.g., sodium alkylsulfate and sodium alkylsulfonate; ampholytic surfactants, e.g., alkylaminocarboxylate salt and alkylaminodicarboxylate salt; and nonionic surfactants, e.g., polyoxyethylene alkyl phenyl ether, can be added to the (co)polymers each in an amount of several weight %.

The layer thickness of the protective layer is preferably from 0.05 to 4.0 μm, and particularly preferably from 0.1 to 2.5 μm.

The adhesion of the protective layer with an image part and scratch resistance are also very important in treating a lithographic printing plate precursor. That is, when a protective layer that is hydrophilic by containing a water-soluble polymer compound is laminated on a lipophilic image-recording layer, layer peeling of the protective layer due to insufficient adhesion is liable to occur, and sometimes a defect such as film hardening failure attributing to polymerization hindrance by oxygen is caused at the peeled part.

Various countermeasures have been proposed for improving the adhesion of an image-recording layer and a protective layer. For example, it is disclosed in JP-A-49-70702 and British Patent Application No. 1,303,578 that sufficient adhesion can be obtained by mixing from 20 to 60 weight % of an acryl-based emulsion or a water-insoluble vinyl pyrrolidone/vinyl acetate copolymer with a hydrophilic polymer mainly comprising polyvinyl alcohol and laminating the resulting product on an image-recording layer. Any of these well-known techniques can be used in the present invention. The coating methods of a protective layer are disclosed in detail, e.g., in U.S. Pat. No. 3,458,311 and JP-B-55-49729.

Further, other functions can be imparted to a protective layer. For example, by the addition of colorants excellent in transmission of infrared rays that are used in exposure and capable of efficiently absorbing lights of other wavelengths (e.g., water-soluble dyes), safelight aptitude can be improved without causing sensitivity reduction.

Exposure of Lithographic Printing Plate Precursor and Printing:

The lithographic printing plate precursor in the invention is imagewise exposed with an infrared laser.

The infrared lasers for use in the present invention are not particularly restricted, but solid state lasers and semiconductor lasers radiating the infrared rays of the wavelength of from 760 to 1,200 nm are preferably used. The output of infrared lasers is preferably 100 mW or higher. It is preferred to use a multi-beam laser device for expediting exposure.

The exposure time per a pixel is preferably not longer than 20 μsec. The quantity of irradiation energy is preferably from 10 to 300 mJ/cm².

After being subjected to imagewise exposure with infrared laser beams, the lithographic printing plate precursor in the invention is used in lithographic printing using oily ink and aqueous component without undergoing any development process.

Specifically, a method of subjecting a lithographic printing plate precursor to infrared laser exposure, and then mounting the exposed printing plate precursor on a printing press without undergoing development process and perform printing, and a method of mounting a lithographic printing plate precursor on a printing press, and then exposing the printing plate precursor with infrared laser beams on the printing press, and perform printing without subjecting to development process are exemplified.

When a lithographic printing plate precursor is imagewise exposed with infrared laser beams and printing is performed by supplying oily ink and aqueous component without being subjected to development process such as wet development process, the image-recording layer hardened by exposure forms an oily ink-accepting area having a lipophilic surface at the exposed area of the image-recording layer. On the other hand, at the unexposed area, an unhardened image-recording layer is dissolved or dispersed with the supplied aqueous component and/or oily ink and removed, whereby a hydrophilic surface is bared at that area.

As a result, the aqueous component adheres to the bared hydrophilic surface, the oily ink adheres to the image-recording layer in the exposed area, and printing is initiated. Here, the one supplied first to the printing plate may be oily ink or may be an aqueous component, but for preventing the aqueous component from becoming dirty by the image-recording layer at the unexposed area, it is preferred to supply oily ink in the first place. As the aqueous component and the oily ink, fountain solutions and oily inks used in ordinary lithographic printing are used.

In this manner, a lithographic printing plate precursor is subjected to on-press development on an offset printer and used in printing of a plenty of sheets.

### EXAMPLE

The present invention is described in detail below with reference to examples, but the invention is not limited thereto.

### Examples 1 to 7 and Comparative Examples 1 to 3

Preparation of Interleaving Sheet:

Interleaving Sheet 1:

To a stuff obtained by beating bleached kraft pulp and being diluted to concentration of 4 weight %, 0.4 weight % of a rosin size was added, and then aluminum sulfate was added in an amount to reach pH of 5.0. A strengthening agent comprising starch as the main component was coated to the stuff in an amount of 3.0 weight %, whereby interleaving sheet 1 having Beck's smoothness of the surface of the side in contact with the outermost surface of the negative type recording layer of 60 seconds, density of 0.8 g/cm³, a moisture content of 6.0 weight %, and a basis weight of 38 g/m² was prepared. The specification of interleaving sheet 1 is shown in Table 2 below.

Interleaving Sheet 2:

As interleaving sheet 2, the paper made of the stuff of 100 weight % of bleached kraft pulp of a broad-leaved tree by using the same size and strengthening agent, having Beck's smoothness of the surface of the side in contact with the outermost surface of the negative type recording layer of about 500 seconds, density of 0.8 g/cm³, a moisture content of 4.5 weight %, pH of 5.5, and a basis weight of 30 g/m² was used. The specification of interleaving sheet 2 is shown in Table 2 below.

TABLE 2

| | Basis | Beck's | Moisture | |
|---|---|---|---|---|
| | Weight | Smoothness | Content | Density |
| | (g/cm²) | (sec) | (%) | (g/cm³) |
| Interleaving | 38 | 60 | 6 | 0.8 |
| sheet 1 | | | | |
| Interleaving | 30 | 500 | 4.5 | 0.8 |
| sheet 2 | | | | |

Manufacture of Lithographic Printing Plate Precursor:
Manufacture of Support:

An aluminum plate having a thickness of 0.3 mm (material 1050) was subjected to degreasing treatment with a 10 weight % sodium aluminate aqueous solution at 50° C. for 30 seconds for removing the rolling oil of the surface, and then the aluminum surface was subjected to brush-graining with three nylon brushes planted with hairs having a hair diameter of 0.3 mm and a suspension of pumice stone and water of a median diameter of 25 μm (the specific gravity: 1.1 g/cm³), and the surface of the plate was thoroughly washed with water. The plate was immersed in a 25 weight % sodium hydroxide aqueous solution at 45° C. for 9 seconds for etching, and then washed with water. After water washing, the plate was further immersed in a 20 weight % nitric acid aqueous solution at 60° C. for 20 seconds, followed by washing with water. The etched amount of the surface by graining was about 3 g/m².

Electrochemical surface roughening treatment was performed continuously by alternating voltage of 60 Hz. The electrolyte at this time was an aqueous solution containing 1 weight % of a nitric acid (containing 0.5 weight % of an aluminum ion) and the liquid temperature was 50° C. As the alternating current electric source waveform, trapezoidal rectangular waveform alternating current was used, the time TP required for the electric current value to reach the peak from 0 was 0.8 msec, the duty ratio was 1:1, and electrochemical surface roughening treatment was performed with a carbon electrode as the counter electrode. Ferrite was used as the auxiliary anode. The electric current density was 30 A/dm² at a peak value of electric current, and 5% of the electric current from the electric source was diverted to the auxiliary anode. The quantity of electricity in the nitric acid electrolysis was 175 C/dm² of the quantity of electricity in the case where the aluminum plate was the anode. The aluminum plate was then washed with water.

Subsequently, electrochemical surface roughening treatment of the aluminum plate was performed in the same manner as in the above nitric acid electrolysis with an electrolyte containing a 0.5 weight % hydrochloric acid aqueous solution (containing 0.5 weight % of an aluminum ion) at a liquid temperature of 50° C. on the condition of 50 C/dm² of the quantity of electricity in the case where the aluminum plate was the anode, and the plate was then subjected to spray washing. The plate was provided with 2.5 g m² of a direct current anodized oxide film with a 15 weight % sulfuric acid aqueous solution (containing 0.5 weight % of an aluminum ion) as the electrolyte and the electric current density of 15 A/dm², washed with water, dried, and further subjected to treatment with a 2.5 weight % sodium silicate aqueous solution at 30° C. for 10 seconds. The central line average surface roughness (Ra) of the plate measured with a needle having a diameter of 2 μm was 0.51 μm.

Formation of Image-Recording Layer:

Each of the image-recording layer coating solutions (1) to (5) having the composition shown below was coated on the above support with bar coating, and dried in an oven at 100° C. for 60 seconds to form an image-recording layer having a dry coating weight of 1.0 g/m², whereby lithographic printing plate precursors (1) to (5) were prepared.

| Image-recording layer coating solution (1): | | |
|---|---|---|
| Infrared absorber (1) shown below | 0.05 | g |
| Polymerization initiator (1) shown below | 0.2 | g |
| Binder polymer (1) shown below | 0.5 | g |
| (average molecular weight: 80,000) | | |
| Polymerizable compound | 1.0 | g |
| Isocyanuric acid EO-modified triacrylate | | |
| (NK Ester M-315, manufactured bby | | |
| Shin Nakamura Kagaku Co., Ltd.) | | |
| Naphthalene sulfonate of Victoria Pure Blue | 0.02 | g |
| Fluorine surfactant (1) shown below | 0.1 | g |
| Methyl ethyl ketone | 18.0 | g |

Infrared Absorber (1)

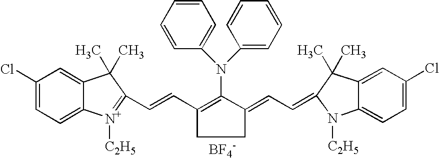

Polymerization Initiator (1)

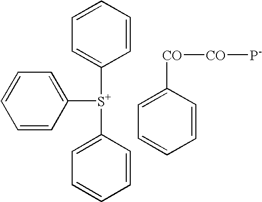

Binder Polymer (1)

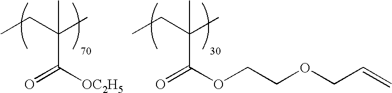

Fluorine Surfactant (1)

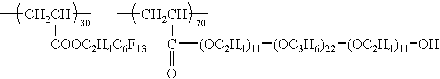

Image-recording layer coating solution (2):

| | |
|---|---|
| Water | 24.3 g |
| Propylene glycol monomethyl ether | 86.1 g |
| Methyl ethyl ketone | 10.9 g |
| Microcapsule (1) shown below | 26.4 g |
| (a 15 weight % aqueous solution) | |
| Polymerization initiator (1) shown above | 1.0 g |
| Infrared absorber (1) shown above | 0.2 g |
| Binder polymer (1) shown above | 1.6 g |
| (average molecular weight: 80,000) | |
| Polymerizable compound | 3.9 g |
| Isocyanuric acid EO-modified triacrylate | |
| (NK Ester M-315, manufactured by | |
| Shin Nakamura Kagaku Co., Ltd.) | |
| Naphthalene sulfonate of Victoria Pure Blue | 0.01 g |
| Fluorine surfactant (1) shown above | 0.8 g |
| (a 10 weight % aqueous solution) | |

Synthesis of Microcapsule (1):

As oil phase components, 10 g of the addition product of trimethylolpropane and xylylene diisocyanate (Takenate D-110N, manufactured by Mitsui Takeda Chemical, Inc.), 3.15 g of pentaerythritol triacrylate (SR 444, manufactured by Nippon Kayaku Co., Ltd.), 0.35 g of infrared absorber (1) shown above, 1 g of 3-(N,N-diethylamino)-6-methyl-7-anilinofluoran (ODB, manufactured by Yamamoto Chemicals Inc.), and 0.1 g of Pionin A-41C (manufactured by Takemoto Oil & Fat) were dissolved in 17 g of ethyl acetate. As an aqueous phase component, 40 g of a 4 weight % aqueous solution of PVA-205 was prepared. The oil phase components and the aqueous phase component were mixed, and they were emulsified in a homogenizer at 12,000 rpm for 10 minutes. The emulsified product was added to 25 g of distilled water, stirred at room temperature for 30 minutes and then at 40° C. for 3 hours. The thus-obtained microcapsule solution was diluted with distilled water to solids content concentration of 15 weight %. The average particle size of the microcapsule solution was 0.3 μm.

Image-recording layer coating solution (3):

| | |
|---|---|
| Water | 23.5 g |
| Propylene glycol monomethyl ether | 86.1 g |
| Methyl ethyl ketone | 10.9 g |
| Microcapsule (1) shown above | 26.4 g |
| (a 15 weight % aqueous solution) | |
| Polymerization initiator (1) shown above | 1.0 g |
| Infrared absorber (1) shown above | 0.2 g |
| Binder polymer (1) shown above | 1.0 g |
| (average molecular weight: 80,000) | |
| Polymerizable compound | 3.9 g |
| Isocyanuric acid EO-modified triacrylate | |
| (NK Ester M-315, manufactured by | |
| Shin Nakamura Kagaku Co., Ltd.) | |
| Inorganic fine particle colloidal silica | 1.4 g |
| (a 40 weight % aqueous solution) (Snowtex | |
| MP-2040, manufactured by Nissan Chemical | |
| Industries, Ltd., particle size: 0.2 μm) | |
| Naphthalene sulfonate of Victoria Pure Blue | 0.01 g |
| Fluorine surfactant (1) shown above | 0.8 g |
| (a 10 weight % aqueous solution) | |

Image-recording layer coating solution (4):

| | |
|---|---|
| Water | 24.3 g |
| Propylene glycol monomethyl ether | 86.1 g |
| Methyl ethyl ketone | 10.9 g |
| Microcapsule (1) shown above | 26.4 g |
| (a 15 weight % aqueous solution) | |
| Polymerization initiator (1) shown above | 1.0 g |
| Infrared absorber (1) shown above | 0.2 g |
| Binder polymer (1) shown above | 1.0 g |
| (average molecular weight: 80,000) | |
| Polymerizable compound | 3.9 g |
| Isocyanuric acid EO-modified triacrylate | |
| (NK Ester M-315, manufactured by | |
| Shin Nakamura Kagaku Co., Ltd.) | |
| Sliding agent (dodecyl stearate) | 0.6 g |
| Naphthalene sulfonate of Victoria Pure Blue | 0.01 g |
| Fluorine surfactant (1) shown above | 0.8 g |
| (a 10 weight % aqueous solution) | |

Image-recording layer coating solution (5):

| | |
|---|---|
| Water | 24.3 g |
| Propylene glycol monomethyl ether | 86.1 g |
| Methyl ethyl ketone | 10.9 g |
| Microcapsule (1) shown above | 26.4 g |
| (a 15 weight % aqueous solution) | |
| Polymerization initiator (1) shown above | 1.0 g |
| Infrared absorber (1) shown above | 0.2 g |
| Binder polymer (1) shown above | 1.0 g |
| (average molecular weight: 80,000) | |
| Polymerizable compound | 3.9 g |
| Isocyanuric acid EO-modified triacrylate | |
| (NK Ester M-315, manufactured by | |
| Shin Nakamura Kagaku Co., Ltd.) | |
| Sliding agent (dodecyl stearate) | 1.2 g |
| Naphthalene sulfonate of Victoria Pure Blue | 0.01 g |
| Fluorine surfactant (1) shown above | 0.8 g |
| (a 10 weight % aqueous solution) | |

Preparation of Stack and Evaluation:

Each stack was prepared by interlaminating the obtained interleaving sheets 1 and 2, and lithographic printing plate precursors (1) to (5) by turns by the combination as shown in Table 3 below. The scratch resistance and the carrying property were evaluated by the following methods. The results obtained are shown in Table 3.

Scratch Resistance:

Each stack formed was set in the cassette of the exposure unit (Trendsetter VX, manufactured by CREO) and carried on the exposure unit from the set part through the exposure part (exposure conditions: output: 9 W, external drum rotation: 210 rpm, and resolution: 2,400 dpi) to the stocker with the autoloader, and the obtained exposed printing plate precursor was attached to the cylinder of the printing press SOR-M (manufactured by Heidelberg Japan K.K.) without development. After supplying a fountain solution (etching solution EU-3, manufactured by Fuji Photo Film Co., Ltd.)/water/isopropyl alcohol in proportion of 1/89/10 (by volume) and TRANS-G(N) black ink (manufactured by Dainippon Ink and Chemicals Inc.) as the fountain solution and ink, 500 sheets of paper were printed at a printing speed of 6,000 sheets/hour. It was confirmed that on-press development had been completed in all Examples and Comparative Examples until 500 sheets of paper were printed. Soiling in the non-image area ascribable to a scratch and the presence of a blank area in the image area of the 500th print were visually observed, and these were made as the criteria of scratch resistance.
o: Neither scratch-like soiling nor a blank area is observed.
Δ: Scratch-like soiling or a blank area is slightly observed.
x: Scratch-like soiling or a blank area is observed.
   Evaluation of Carrying Property:

The stack formed was piled in a height of 15 cm on a vibrator (Kudo Ace 1000, manufactured by KUDO IRON WORKS CO., LTD.) maintained horizontal, and vibrated at graduation 60 of vibrating dial for 10 minutes, and the slippage of the lithographic printing plate precursors in the horizontal direction (mm) was measured, and the value was used as the criterion of the evaluation.

TABLE 3
Examples 1 to 7 and Comparative Examples 1 to 3

| | Lithographic | | Dynamic | | |
|---|---|---|---|---|---|
| | Printing | In- | Friction | Scratch | Carrying |
| | Plate | terleaving | Coeffi- | Resis- | Property |
| Example No. | Precursor | sheet | cient | tance | (mm) |
| Example 1 | (1) | (2) | 0.67 | Δ | 1 |
| Example 2 | (2) | (1) | 0.62 | ∘ | 1 |
| Example 3 | (2) | (2) | 0.55 | ∘ | 2 |
| Example 4 | (3) | (1) | 0.57 | ∘ | 2 |
| Example 5 | (3) | (2) | 0.50 | ∘ | 4 |
| Example 6 | (4) | (1) | 0.48 | ∘ | 4 |
| Example 7 | (4) | (2) | 0.42 | ∘ | 5 |
| Comparative | (1) | (1) | 0.75 | x | 0 |
| Example 1 | | | | | |
| Comparative | (5) | (1) | 0.22 | ∘ | 27 |
| Example 2 | | | | | |
| Comparative | (5) | (2) | 0.17 | ∘ | 36 |
| Example 3 | | | | | |

From the above results, it can be seen that in Comparative Examples in which the dynamic friction coefficients are out of the scope of the present invention, at least either scratch resistance or carrying property is inferior. On the other hand, in Examples in which the dynamic friction coefficients are within the scope of the present invention, scratch resistance and carrying property are both excellent, and these properties are particular excellent when microcapsules and inorganic fine particles are used.

The present invention can provide a stack of lithographic printing plate precursors improved in a scratch resisting property in carriage and exposure and capable of image recording by infrared lasers and on-press development.

The entire disclosure of each and every foreign patent application from which the benefit of foreign priority has been claimed in the present application is incorporated herein by reference, as if fully set forth.

1. A stack of lithographic printing plate precursors, which comprises:
at least one lithographic printing plate precursor comprising: an aluminum support having a roughened surface; and an image recording layer comprising (A) an infrared absorber, (B) a polymerization initiator and (C) a polymerizable compound, wherein the image recording layer is capable of being removed with at least one of a printing ink and a fountain solution; and
an interleaving sheet interposed between a first one and a second one of said at least one lithographic printing plate precursor,
wherein said at least one lithographic printing plate precursor has a dynamic friction coefficient between an outermost surface of said at least one lithographic printing plate precursor and the interleaving sheet of 0.25 to 0.70.

2. The stack of lithographic printing plate precursors according to claim 1,
wherein an interleaving sheet is interposed between each of a first one and each of a second one of said at least one lithographic printing plate precursor.

3. The stack of lithographic printing plate precursors according to claim 2, which further comprises an interleaving sheet as a top of the stack of lithographic printing plate precursors.

4. The stack of lithographic printing plate precursors according to claim 1,
wherein the outermost surface is a surface to be exposed when the interleaving sheet is removed.

5. The stack of lithographic printing plate precursors according to claim 4,
wherein the outermost surface is an outermost surface of the image recording layer.

6. The stack of lithographic printing plate precursors according to claim 4,
wherein said at least one lithographic printing plate precursor further comprises at least one layer on the image recording layer,
wherein the outermost surface is an outermost surface of one of said at least one layer that is an opposite side of the aluminum support.

7. The stack of lithographic printing plate precursors according to claim 1, further comprising a protecting board.

8. The stack of lithographic printing plate precursors according to claim 1,
wherein the image recording layer further comprises microcapsules encapsulating at least one of (A) an infrared absorber, (B) a polymerization initiator and (C) a polymerizable compound.

9. The stack of lithographic printing plate precursors according to claim 1,
wherein the image recording layer further comprises (D) inorganic particles.

10. A packaged stack comprising:
a stack of lithographic printing plate precursors according to claim 1; and
a package.

11. The packaged stack according to claim 10,
wherein the package is a wrapper.
